(19) United States
(12) Patent Application Publication
(10) Pub. No.: US 2024/0240106 A1
(43) Pub. Date: Jul. 18, 2024

(54) 1,4-BUTANEDIOL MONO- OR DIESTERS FOR USE AS AROMA CHEMICALS

(71) Applicant: BASF SE, Ludwigshafen am Rhein (DE)

(72) Inventors: Christoph STOCK, Ludwigshafen am Rhein (DE); Florian GARLICHS, Lampertheim (DE); Ralf PELZER, Lampertheim (DE); Miriam BRU ROIG, Lampertheim (DE)

(21) Appl. No.: 18/562,862

(22) PCT Filed: May 25, 2022
(86) PCT No.: PCT/EP2022/064261

§ 371 Date: Nov. 21, 2023

(30) Foreign Application Priority Data
May 27, 2021 (EP) 21176301.6
Sep. 16, 2021 (EP) 21197072.8

(51) Int. Cl. C11B 9/00

(52) U.S. Cl. CPC C11B 9/0019

(57) ABSTRACT

The present invention relates to the use of 1,4-butanediol mono- or diesters of the formula (I) R¹—O—(CH₂)₄—O—C(═O)—R² where R¹ is hydrogen or —C(═O)—R³; and R² and R³ are independently C₁-C₂-alkyl; or of a mixture of different compounds (I) as aroma chemicals; to the use thereof for modifying and/or enhancing the aroma of a composition, to a composition comprising such 1.4-butanediol mono- and/or diesters and to a method for preparing an aromatized composition using said 1,4-butanediol mono- and/or diesters.

The present invention relates to the use of 1,4-butanediol mono- or diesters of the formula (I) as depicted below or of a mixture thereof as aroma chemicals, to the use thereof for modifying and/or enhancing the aroma of a composition, to a composition comprising such 1,4-butanediol mono- and/or diesters of the formula (I) and to a method for preparing an aromatized composition using said 1,4-butanediol mono- and/or diesters.

### BACKGROUND OF THE INVENTION

Aroma chemicals, especially fragrances, are of great interest especially in the field of cosmetics and cleaning and laundry compositions. Fragrances of natural origin are mostly expensive, often limited in their available amount and, on account of fluctuations in environmental conditions, are also subject to variations in their content, purity etc. To circumvent these undesirable factors, it is therefore of great interest to create synthetic substances which have sensory properties that resemble more expensive natural fragrances or which have novel and interesting sensory profiles.

Despite a large number of already existing aroma chemicals, there is a constant need for new components in order to be able to satisfy the multitude of properties desired for extremely diverse areas of application. These include, firstly, the sensory properties, i.e. the compounds should have advantageous odiferous (olfactory) or gustatory properties. Furthermore, aroma chemicals should also have additional positive secondary properties, such as e.g. an efficient preparation method, the possibility of providing better sensory profiles as a result of synergistic effects with other aroma chemicals, a higher stability in a wide range of compositions as well as under certain application conditions, a higher extendability and/or a better staying power.

However, since even small changes in chemical structure bring about massive changes in the sensory properties such as odor and also taste, the targeted search for substances with certain sensory properties such as a certain odor is extremely difficult. The search for new fragrances and flavorings is therefore in most cases difficult and laborious without knowing whether a substance with the desired odor and/or taste will even actually be found.

DE 886304 B describes the preparation of various 1,4-butanediol esters, such as 1,4-butanediol diacetate or dibutyrate, by reaction of tetrahydrofuran with carboxylic acids in the presence of an esterifying catalyst. The esters are said to be useful as solvents, plasticisers, intermediate compounds, plastics or starting compounds for fragrances and pharmaceutical compositions. This document does however not describe any olfactory properties of the esters themselves.

DE-A-2525893 describes a method for preparing cellulose actate fiber rods suitable for cigarette filters in which method 1,4-butanediol diacetate is used as plasticiser. 1,4-Butanediol diacetate is characterized as odorless and non toxic and as not compromising the cigarette flavor or the smoke aroma.

CN 103642260 relates to a deodorizing material containing glass fibers, methacrylic acid, cotton fibers, charcoal powder, polyester fibers and a diacetate, such as 1,4-butanediol diacetate. The material is characterized as odorless.

V. Ferreira et al. describe in J. Chromatogr. 1999, 864, 77-88 a semipreparative reversed-phase liquid chromatography fractionation of wine extracts and other alcoholic beverages. One of the many separated fractions of Chardonnay wine contains acetaldehyde, ethyl lactate, furfural, ethyl 3-hydroxybutyrate, methionol, 1,4-butanediol diacetate and diethyl malate; its aroma is described as yeast extract, wet, weak. 1,4-Butanediol diacetate is not specifically described as having an aroma.

A. Rapp et al. describe in Vitis, 1989, 28, 21-29 gaschromatgraphic investigations comparing the volatiles of wines of Vitis vinifera and fungus resistant grapevine varieties. Among many others, 1,4-butanediol monoacetate is identified as a component of these volatiles. It is however not described as having a specific aroma.

M. G. Moshonas et al. describe in Lebensm.-Wiss. u.-Technol. 1993, 26, 577-589 volatile and non-volatile components in Hami melon. Among many others, 1,4-butanediol diacetate is identified as a volatile. It is however not specifically described as having an aroma.

CN 104824121 A relates to a turkey meat surface spraying antistaling agent. This comprises inter alia 2,3-diacetyl and BDO diacetate esters.

WO 2011/101352 relates to a liquid mixture comprising a) a polyol, a polyolether with at least one unetherified hydroxyl group or a polyalkylene ether with at least one unetherified terminal hydroxyl group, b) 1,3-bis(caprolactam-1-yl) butane and c) diacetoxybutane, which mimics the solubility properties of specific graft copolymers.

It was the object of the present invention to provide new aroma chemicals. Besides, these substances should be combinable with other aroma chemicals, allowing the creation of novel advantageous sensory profiles. In addition, the process for the preparation of these new aroma chemicals should be easy and efficient to allow their fast, economic and environmentally friendly manufacturing. A particular object was to provide aroma chemicals with a reduced carbon footprint, especially aroma chemicals which are at least partially available from renewable sources. Another particular object was to provide aroma chemicals with a fruity aroma, preferably with a fruity and sweet aroma.

These and further objects are achieved by the ester of formula (I) or mixtures thereof [i.e. mixtures of different compounds (I), to be more precise of two or more different compounds (I)] as shown below.

### SUMMARY OF THE INVENTION

The invention relates to the use of a 1,4-butanediol mono- or diester of the formula (I)

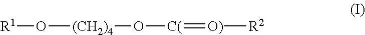

where
R¹ is selected from the group consisting of hydrogen and —C(═O)—R³; and
R² and R³, independently of each other, are C₁-C₂-alkyl;
or of a mixture of two or more different 1,4-butanediol mono- and/or diesters of the formula (I)
as an aroma chemical.

Thus, surprisingly and in contradiction to what is insinuated in the prior art, 1,4-butanediol diacetate is not odourless at all, but has a very pleasant aroma. Its fragrance is not obtrusive, but nevertheless well perceivable. The same holds true for the other esters (I).

The invention relates moreover to the use of a 1,4-butanediol mono- or diester of the formula (I) or of a mixture of different 1,4-butanediol mono- and/or diesters of the formula (I), for modifying and/or enhancing the aroma of a composition; in particular for modifying and/or enhancing the fragrance impression of a composition; specifically for modifying the scent character of a fragranced ready-to-use composition.

The invention relates furthermore to the the use of a 1,4-butanediol mono- or diester of the formula (I) or of a mixture of different 1,4-butanediol mono- and/or diesters of the formula (I), for imparting an aroma to a composition, preferably for imparting an aroma to a personal care or homecare composition, alternatively preferably for imparting a fragrance to a composition, alternatively preferably for imparting a fruity or sweet or a combined fruity and sweet aroma to a composition, more preferably for imparting a fruity or sweet or a combined fruity and sweet fragrance to a composition, in particular for imparting a fruity or sweet or a combined fruity and sweet fragrance to a personal care or homecare composition.

The invention relates also to a composition comprising a 1,4-butanediol mono- or diester of the formula (I) or a mixture of different 1,4-butanediol mono- and/or diesters of the formula (I), and at least one further component selected from the group consisting of aroma chemicals different from compounds (I), non-aroma chemical carriers, anti-oxidants and deodorant-active agents.

The invention relates further to a method for preparing an aroma chemical composition, in particular a fragranced composition, specifically a fragranced ready-to-use composition, comprising incorporating a 1,4-butanediol mono- or diester of the formula (I) or a mixture of different 1,4-butanediol mono- and/or diesters of the formula (I) into said composition, or comprising mixing simultaneously or consecutively a 1,4-butanediol mono- or diester of the formula (I) or a mixture of different 1,4-butanediol mono- and/or diesters of the formula (I) with the other components of said composition or with preformed mixtures of a part of the other components of said composition.

The invention relates also to a method for conferring an aroma, preferably a fragrance, to a composition by incorporating a 1,4-butanediol mono- or diester of the formula (I) or a mixture of different 1,4-butanediol mono- and/or diesters of the formula (I) into said composition, or by mixing simultaneously or consecutively a 1,4-butanediol mono- or diester of the formula (I) or a mixture of different 1,4-butanediol mono- and/or diesters of the formula (I) with the other components of said composition or with pre-formed mixtures of a part of the other components of said composition.

The invention moreover relates to a method of modifying and/or enhancing the aroma of a composition; preferably for modifying and/or enhancing the fragrance impression of a composition; in particular for modifying the scent character of an aroma composition, in particular of a fragranced composition, specifically of a fragranced ready-to-use composition, comprising incorporating at least one compound of formula (I) into a composition, in particular into a ready-to-use composition, or comprising mixing simultaneously or consecutively a 1,4-butanediol mono- or diester of the formula (I) or a mixture of different 1,4-butanediol mono- and/or diesters of the formula (I) with the other components of said composition or with pre-formed mixtures of a part of the other components of said composition.

### DETAILED DESCRIPTION OF THE INVENTION

### Definitions

In the context of the present invention, the term “aroma” refers to a sensory property and comprises an odor and/or a flavor.

The term “aroma chemical” denotes a substance which is used to obtain an aroma impression (the term “aroma impression” is used interchangeably herein with the term “note”) and comprises its use to obtain an olfactory and/or a flavor impression. The term “olfactory impression” or “odor impression” denotes an odor impression without any positive or negative judgement, while the term “scent impression” or “fragrance impression” (used interchangeably herein) as used herein is connected to an odor impression which is generally felt as pleasant. Thus a “fragrance” or “scent” denotes an aroma chemical which predominately induces a pleasant odor impression. A flavor denotes an aroma chemical which induces a taste impression.

The term “aroma profile” denotes the overall aroma impression of an aroma chemical and is composed of the individual aroma impressions of an aroma chemical.

The term “aroma composition”, as used herein, refers to a composition which induces an aroma. The term aroma composition comprises “odor composition” and/or “flavor composition”. An odor composition is a composition which predominately induces an odor impression, whereas a flavor composition is a composition which predominantly induces a taste impression.

The term “odor composition” comprises “fragrance composition” or “scent composition” (used interchangeably herein), which predominately induce an odor impression which is generally felt as pleasant.

“Pleasant odor”, “pleasant odor impression”, “pleasant odiferous properties”, “odor impression felt as pleasant” and similar terms are hedonistic expressions which describe the niceness and conciseness of an odor impression conveyed by an aroma chemical. The more general hedonistic expressions “advantageous sensory properties” or “advantageous organoleptic properties” describe the niceness and conciseness of an organoleptic impression conveyed by an aroma chemical. In terms of the present invention, the terms “organoleptic” and “sensory” relate to olfactory or flavor properties. “Niceness” and “conciseness” are terms which are familiar to the person skilled in the art, a perfumer. Niceness generally refers to a spontaneously brought about, positively perceived, pleasant sensory impression. However, “nice” does not have to be synonymous with “sweet”. “Nice” can also be the odor of musk or sandalwood. “Conciseness” generally refers to a spontaneously brought about sensory impression which—for the same test panel—brings about a reproducibly identical reminder of something specific. For example, a substance can have an odor which is spontaneously reminiscent of that of an “apple”: the odor would then be concisely of “apples”. If this apple odor were very pleasant because the odor is reminiscent, for example, of a sweet, fully ripe apple, the odor would be termed “nice”. However, the odor of a typical apple tart can also be concise. If both reactions arise upon smelling the substance, in the example thus a nice and concise apple odor, then this substance has particularly advantageous sensory properties.

The term “odor-intensive substances” refers to substances or aroma chemicals exhibiting intense odor impressions. Intense odor impressions are to be understood as meaning those properties of aroma chemicals which permit a striking perception even in very low gas space concentrations.

The intensity can be determined via a threshold value determination. A threshold value is the concentration of a substance in the relevant gas space at which an odor impression can just still be perceived by a representative test panel, although it no longer has to be defined. A substance class which probably belongs to the most odor-intensive known substance classes, i.e. has very low odor threshold values, are thiols, whose threshold value is often in the ppb/m³ range.

The term “tenacity” describes the evaporation behavior over time of an aroma chemical. The tenacity can for example be determined by applying the aroma chemical to a test strip, and by subsequent olfactory evaluation of the odor impression of the test strip. For aroma chemicals with high tenacity the time span after which the panel can still identify an aroma impression is long.

The term “substantivity” describes the interaction of an aroma chemical with a surface, such as for example the skin or a textile, especially after subsequent treatment of the surface, such as for example washing. The substantivity can for example be determined by washing a textile with a textile detergent composition comprising the aroma chemical and subsequent olfactory evaluation of the textile directly after washing (wet textile) as well as evaluation of the dry textile after prolonged storage.

The term “stability” describes the behavior of an aroma chemical upon contact with oxygen, light and/or other substances. An aroma chemical with high stability maintains its aroma profile over a long period in time, preferably in a large variety of compositions and under various storage conditions.

In order to impart a long-lasting aroma impression to a composition or to a surface treated with a composition, the tenacity, the substantivity as well as the stability of the aroma chemical in the compositions should preferably be high.

The term “booster”, “boosting” or “boost” is used herein to describe the effect of enhancing and/or modifying the aroma of an aroma chemical or of a composition. The term “enhancing” comprises an improvement of the niceness and/or conciseness of an aroma and/or an improvement of the intensity. The term “modifying” comprises the change of an aroma profile.

Booster effects are particularly desired in fragrance composition when top-note-characterized applications are required, in which the odor is to be conveyed particularly quickly and intensively, for example in deodorants, air fresheners or in the taste sector in chewing gums.

The terms “compound” and “substance” are used synonymously throughout the invention.

In the context of the present invention, the expression “C₁-C₂-alkyl” refers to methyl and ethyl.

A 1,4-butanediol monoesters of the formula (I) is a compound (I) wherein R¹ is hydrogen. A 1,4-butanediol diester of the formula (I) is a compound (I) wherein R¹ is —C(═O)—R³.

If in the following the compound of formula (I) is defined to be a specific, defined compound (and not to be a mixture of different compounds I), this means that the compound contains less than 0.1% by weight of other compounds I, relative to the overall weight of the specific, defined compound I and the optionally present other compound(s) I.

In mixtures containing different compounds (I), these differ in the definition of the radical R¹, in the definition of the radical R² or in both. The mixtures can thus for example contain monoesters derived from different carboxylic acids, diesters derived from different carboxylic acids, both the mono- and the diester derived from the same carboxylic acid, and both the mono- and the diesters derived from different carboxylic acids. “Derived from” in this context relates only to the theoretical origin of the R²—C(═O)— or R³—C(═O)— group (if present); not to the actual synthetic origin. Preferably, the compounds (I) in the mixture differ only in being either a monoester (R¹═H) or a diester (R¹═—C(═O)—R³), both deriving from the same carboxylic acid (i.e. R² is the same in the mono- and the diester; and R²═R³).

The remarks made below concerning preferred definitions of the variables are valid on their own as well as preferably in combination with each other concerning the compounds of formula (I), as defined herein, where applicable, as well as concerning the compositions, uses and methods of the invention as defined herein.

### Embodiments (E.x) of the Invention

General and preferred embodiments E.x are summarized in the following, non-exhaustive list. Further preferred embodiments become apparent from the paragraphs following this list.

E.1. Use of a 1,4-butanediol mono- or diester of the formula (I)

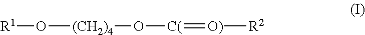

where
R¹ is selected from the group consisting of hydrogen and —C(═O)—R³; and
R² and R³, independently of each other, are C₁-C₂-alkyl;
or of a mixture of two or more different 1,4-butanediol mono- and/or diesters of the formula (I)
as an aroma chemical.
   E.2. The use according to embodiment E.1, where
a 1,4-butanediol diester is used (i.e. R¹ is —C(═O)—R³ and R² and R³ are both C₁-C₂-alkyl); or
a mixture of a 1,4-butanediol diester (i.e. R¹ is —C(═O)—R³ and R² and R³ are both C₁-C₂-alkyl) and a 1,4-butanediol monoester (i.e. R¹ is hydrogen and R² is C₁-C₂-alkyl), is used.
   E.3. The use according to embodiment E.2, where
a 1,4-butanediol diester is used (i.e. R¹ is —C(═O)—R³ and R² and R³ are both C₁-C₂-alkyl); where R² and R³ are identical (i.e. the 1,4-butanediol diester is either 1,4-butanediol diacetate or 1,4-butanediol dipropionate); or
a mixture of a 1,4-butanediol diester (i.e. R¹ is —C(═O)—R³ and R² and R³ are both C₁-C₂-alkyl) and a 1,4-butanediol monoester (i.e. R¹ is hydrogen and R² is C₁-C₂-alkyl) is used; where R² and R³ in the diester and R² in the monoester are identical (i.e. the mixture is either a mixture of 1,4-butanediol diacetate and 1,4-butanediol monoacetate, or is a mixture of 1,4-butanediol dipropionate and 1,4-butanediol monopropionate).
   E.4. The use according to any of the preceding embodiments, where
R¹ is hydrogen or —C(═O)—CH₃; and
R² is methyl.
   E.5. The use according to embodiment E.4, of 1,4-butanediol diacetate (i.e. a compound (I) wherein R¹ is —C(═O)—R³ and R² and R³ are methyl).
   E.6. The use according to embodiment E.4, of a mixture of 1,4-butanediol diacetate (i.e. a compound (I) wherein R¹ is —C(═O)—R³ and R² and R³ are methyl) and 1,4-butanediol monoacetate (i.e. a compound (I) wherein R¹ is H and R² is methyl).
   E.7. The use according to any of embodiments E.1 to E.3, where
R¹ is hydrogen or —C(═O)—CH₂CH₃; and
R² is ethyl.
   E.8. The use according to embodiment E.7, of 1,4-butanediol dipropionate (i.e. a compound (I) wherein R¹ is —C(═O)—R³ and R² and R³ are ethyl).
   E.9. The use according to embodiment E.7, of a mixture of 1,4-butanediol dipropionate (i.e. a compound (I) wherein R¹ is —C(═O)—R³ and R² and R³ are ethyl) and 1,4-butanediol monopropionate (i.e. a compound (I) wherein R¹ is H and R² is ethyl).
   E.10. The use according to any of embodiments E.2 to E.4, E.6, E.7 and E.9, where the mixture contains the 1,4-butanediol monoester in an amount of from 0.1 to 99% by weight, relative to the overall weight of the 1,4-butanediol diester and the 1,4-butanediol monoester.
   E.11. The use according to embodiment E.10, where the mixture contains the 1,4-butanediol monoester in an amount of from 0.1 to <50% by weight, relative to the overall weight of the 1,4-butanediol diester and the 1,4-butanediol monoester.
   E.12. The use according to embodiment E.11, where the mixture contains the 1,4-butanediol monoester in an amount of from 0.1 to 30% by weight, relative to the overall weight of the 1,4-butanediol diester and the 1,4-butanediol monoester.
   E.13. The use according to embodiment E.12, where the mixture contains the 1,4-butanediol monoester in an amount of from 0.1 to 20% by weight, relative to the overall weight of the 1,4-butanediol diester and the 1,4-butanediol monoester.
   E.14. The use according to embodiment E.13, where the mixture contains the 1,4-butanediol monoester in an amount of from 0.1 to 10% by weight, relative to the overall weight of the 1,4-butanediol diester and the 1,4-butanediol monoester.
   E.15. The use according to embodiment E.14, where the mixture contains the 1,4-butanediol monoester in an amount of from 0.1 to 5% by weight, relative to the overall weight of the 1,4-butanediol diester and the 1,4-butanediol monoester.
   E.16. The use according to embodiment E.15, where the mixture contains the 1,4-butanediol monoester in an amount of from 0.1 to 2% by weight, relative to the overall weight of the 1,4-butanediol diester and the 1,4-butanediol monoester.
   E.17. The use according to embodiment E.16, where the mixture contains the 1,4-butanediol monoester in an amount of from 0.1 to 1% by weight, relative to the overall weight of the 1,4-butanediol diester and the 1,4-butanediol monoester.
   E.18. The use according to embodiment E.17, where the mixture contains the 1,4-butanediol monoester in an amount of from 0.1 to 0.5% by weight, relative to the overall weight of the 1,4-butanediol diester and the 1,4-butanediol monoester.
   E.19. The use according to any of the preceding embodiments, where the 1,4-butanediol mono- or diester of the formula (I) is derived from 1,4-butanediol which is obtained from a renewable source.
   E.20. The use according to embodiment E.19, where the 1,4-butanediol mono- or diester of the formula (I) is derived from 1,4-butanediol which is obtained from a renewable source and from a carboxylic acid R²—C(═O)OH and R³—C(═O)OH, if R¹ is —C(═O)—R³, which is/are obtained from a renewable source.
   E.21. The use according to any of embodiments E.19 or E.20, where the ¹⁴C isotope in the 1,4-butanediol ester is at a detectable level.
   E.22. The use according to any of embodiments E.19 to E.21, where in the 1,4-butanediol the molar ratio of the ¹²C isotope to the ¹⁴C isotope is less than 2×10¹²: 1.
   E.23. The use according to any of embodiments E.19 to E.22, where in the 1,4-butanediol mono- or diester of the formula (I) the molar ratio of the ¹²C isotope to the ¹⁴C isotope is less than 3×10¹²: 1.
   E.24. The use according to any of the preceding embodiments, as a fragrance.
   E.25. The use of a 1,4-butanediol mono- or diester of the formula (I) or of a mixture of different 1,4-butanediol mono- and/or diesters of the formula (I) as defined in any of embodiments E.1 to E.23, for modifying and/or enhancing the aroma of a composition.
   E.26. The use according to embodiment E.25, for modifying and/or enhancing the fragrance impression of a composition.
   E.27. The use according to embodiment E.26, for modifying the scent character of a fragranced ready-to-use composition.
   E.28. The use of a 1,4-butanediol mono- or diester of the formula (I) or of a mixture of different 1,4-butanediol mono- and/or diesters of the formula (I) as defined in any of embodiments E.1 to E.23, for conferring a fruity or sweet or combined fruity and sweet olfactory note.
   E.29. The use according to embodiment E.28, of 1,4-butanediol diacetate or of a mixture of 1,4-butanediol diacetate and 1,4-butanediol monoacetate containing preferably 0.1 to 0.5% by weight or 0.1 to 1% by weight or 0.1 to 2% by weight or 0.1 to 5% by weight or 0.1 to 10% by weight or 0.1 to 20% by weight of 1,4-butanediol monoacetate, relative to the overall weight of 1,4-butanediol diacetate and 1,4-butanediol monoacetate, for conferring one of the following olfactory notes: red fruit, raspberry, blueberry, sweet; or any combination thereof.
   E.30. The use according to embodiment E.28, of 1,4-butanediol dipropionate or of a mixture of 1,4-butanediol dipropionate and 1,4-butanediol monopropionate containing preferably 0.1 to 0.5% by weight or 0.1 to 1% by weight or 0.1 to 2% by weight or 0.1 to 5% by weight or 0.1 to 10% by weight of 1,4-butanediol monopropionate, relative to the overall weight of 1,4-butanediol dipropionate and 1,4-butanediol monopropionate, for conferring one of the following olfactory notes: red fruit, raspberry, blueberry, sweet; or any combination thereof.
   E.31. The use according to any of the preceding embodiments, in a composition selected from the group consisting of perfume compositions, body care compositions, products for oral or dental hygiene, hygiene articles, cleaning compositions, textile detergent compositions, compositions for scent dispensers, foods, food supplements, pharmaceutical compositions and crop protection compositions, preferably from perfume compositions, body care compositions, products for oral or dental hygiene, hygiene articles, cleaning compositions, textile detergent compositions, compositions for scent dispensers and crop protection compositions, and in particular from body care compositions, products for oral or dental hygiene, hygiene articles, cleaning compositions, textile detergent compositions, compositions for scent dispensers.
   E.32. The use of a 1,4-butanediol mono- or diester of the formula (I) or of a mixture of different 1,4-butanediol mono- and/or diesters of the formula (I) as defined in any of embodiments E.1 to E.23, for imparting an aroma to a composition.
   E.33. The use according to embodiment 32, for imparting a fragrance to a composition.
   E.34. The use according to embodiment 33, for imparting a fragrance to a personal care or homecare composition.
   E.35. The use according to embodiment 32, for imparting a fruity or sweet or combined fruity and sweet aroma to a composition.
   E.36. The use according to embodiment 35, for imparting a fruity or sweet or combined fruity and sweet fragrance to a composition.
   E.37. The use according to embodiment 36, for imparting a fruity or sweet or combined fruity and sweet fragrance to a personal care or homecare composition.
   E.38. Composition comprising a 1,4-butanediol mono- or diester of the formula (I) or a mixture of different 1,4-butanediol mono- and/or diesters of the formula (I) as defined in any of embodiments E.1 to E.23, and at least one further component selected from the group consisting of aroma chemicals different from compounds (I), non-aroma chemical carriers, anti-oxidants and deodorant-active agents.
   E.39. The composition according to embodiment E.38, where the composition is not an alcoholic beverage, a fruit juice, a fruit or a seed.
   E.40. The composition according to embodiment E.38, where the composition does not comprise diacetyl;
   E.41. The composition according to embodiment E.38, where the composition does not comprise 1,3-bis(caprolactam-1-yl) butane.
   E.42. The composition according to embodiment E.38, where the composition is not an alcoholic beverage, a fruit juice, a fruit or a seed, where the composition does not comprise diacetyl; and where the composition does not comprise 1,3-bis(caprolactam-1-yl) butane.
   E.43. The composition according to any of embodiments E.38 to 42, where the at least one further component is selected from the group consisting of aroma chemicals different from compounds (I), surfactants, oil components, solvents, anti-oxidants and deodorant-active agents.
   E.44. The composition according to embodiment E.43, where in case that the non-aroma chemical carriers comprise one or more solvents, these are selected from the group consisting of ethanol, isopropanol, dipropylene glycol (DPG), propylene glycol, 1,2-butylene glycol, glycerol, diethylene glycol monoethyl ether, diethyl phthalate (DEP), isopropyl myristate (IPM), triethyl citrate (TEC), benzyl benzoate and mixtures thereof.
   E.45. The composition according to embodiment E.44, where the solvents are selected from the group consisting of isopropanol, dipropylene glycol (DPG), propylene glycol, 1,2-butylene glycol, diethylene glycol monoethyl ether, diethyl phthalate (DEP), isopropyl myristate (IPM), triethyl citrate (TEC), benzyl benzoate and mixtures thereof.
   E.46. The composition according to embodiment E.45, where the solvents are selected from the group consisting of isopropanol, isopropyl myristate (IPM), triethyl citrate (TEC), benzyl benzoate and mixtures thereof.
   E.47. The composition according to any of embodiments E.38 to E.46, where the aroma chemicals different from compounds (I) are selected from the group consisting of geranyl acetate (3,7-dimethyl-2,6 octadien-1yl acetate), alpha-hexylcinnamaldehyde, 2-phenoxyethyl isobutyrate (Phenirat¹), dihydromyrcenol (2,6-dimethyl-7-octen-2-ol), methyl dihydrojasmonate (preferably with a content of cis isomer of more than 60 wt. %) (Hedione⁹, Hedione HC⁹), 4,6,6,7,8,8-hexamethyl-1,3,4,6,7,8-hexahydrocyclopenta[g]benzopyran (Galaxolid³), tetrahydrolinalool (3,7-dimethyloctan-3-ol), ethyllinalool, benzyl salicylate, 2-methyl-3-(4-tert-butylphenyl)propanal (Lysmeral²), cinnamyl alcohol, 4,7-methano-3a,4,5,6,7,7a-hexahydro-5-indenyl acetate and/or 4,7-methano-3a,4,5,6,7,7a-hexahydro-6-indenyl acetate (Herbaflorat¹), citronellol, citronellyl acetate, tetra-hydrogeraniol, vanillin, linalyl acetate, styrolyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthalene (Iso E Super³), hexyl salicylate, 4-tert-butylcyclohexyl acetate (Oryclone¹), 2-tert-butylcyclohexyl acetate (Agrumex HC¹), alpha-ionone (4-(2,2,6-trimethyl-2-cyclohexen-1-yl)-3-buten-2-one), n-alpha-methylionone, alpha-isomethylionone, coumarin, terpinyl acetate, 2-phenylethyl alcohol, 4-(4-hydroxy-4-methylpentyl)-3-cyclohexenecarboxaldehyde (Lyral³), alpha-amylcinnamaldehyde, ethylene brassylate, (E)- and/or (Z)-3-methylcyclopentadec-5-enone (Muscenon⁹), 15-pentadec-11-enolide and/or 15-pentadec-12-enolide (Globalide¹), 15-cyclopentadecanolide (Macrolide¹), 1-5,6,7,8-tetrahydro-3,5,5,6,8,8-hexamethyl-2-naphthalenyl)ethanone (Tonalid¹⁰), 2-isobutyl-4-methyltetrahydro-2H-pyran-4-ol (Florol⁹), 2-ethyl-4-(2,2,3-trimethyl-3-cyclopenten-1-yl)-2-buten-1-ol (Sandolen¹), cis-3-hexenyl acetate, trans-3-hexenyl acetate, trans-2/cis-6-nonadienol, 2,4-dimethyl-3-cyclohexenecarboxaldehyde (Vertocitral¹), 2,4,4,7-tetramethyloct-6-en-3-one (Claritone¹), 2,6-dimethyl-5-hepten-1-al (Melonal²), borneol, 3-(3-isopropylphenyl)butanal (Florhydral²), 2-methyl-3-(3,4-methylenedioxyphenyl)propanal (Helional³), 3-(4-ethylphenyl)-2,2-dimethylpropanal (Florazon¹), 7-methyl-2H-1,5-benzodioxepin-3(4H)-one (Calone), 3,3,5-trimethylcyclohexyl acetate (preferably with a content of cis isomers of 70 wt. %) or more, 2,5,5-trimethyl-1,2,3,4,4a,5,6,7-octahydronaphthalen-2-ol (Ambrinol S¹), 3-(4-tert-butylphenyl)-propanal (Bourgeonal⁴), ethyl 2-methylpentanoate (Manzanate⁴), ethoxymethoxycyclododecane (Amberwood¹), 2,4-dimethyl-4,4a,5,9b-tetrahydroindeno[1,2-d][1,3]dioxine (Magnolan¹), (2-tert-butylcyclohexyl) acetate (Verdox³), 3-[5,5,6-trimethylbicyclo[2.2.1]hept-2-yl]cyclohexan-1-ol (Sandela⁴), menthone, isomenthone, carvone, camphor, beta-ionone, beta-n-methylionone, beta-isomethylionone, alpha-irone, alpha-damascone, beta-damascone, beta-damascenone, delta-damascone, acetylated cedar wood oil, and mixtures thereof.
   E.48. The composition according to embodiment E.47, where the aroma chemicals different from compounds (I) are selected from the group consisting of geranyl acetate, alpha-hexylcinnamaldehyde, 2-phenoxyethyl isobutyrate, dihydromyrcenol, methyl dihydrojasmonate (preferably with a content of cis isomer of more than 60 wt. %), 4,6,6,7,8,8-hexamethyl-1,3,4,6,7,8-hexahydrocyclopenta[g]-benzopyran, tetrahydrolinalool, ethyllinalool, benzyl salicylate, 2-methyl-3-(4-tert-butylphenyl)propanal, cinnamyl alcohol, 4,7-methano-3a,4,5,6,7,7a-hexahydro-5-indenyl acetate, 4,7-methano-3a,4,5,6,7,7a-hexahydro-6-indenyl acetate, citronellyl acetate, tetrahydrogeraniol, linalyl acetate, styrolyl acetate, octahydro-2,3,8,8-tetramethyl-2-acetonaphthone, 2-acetyl-1,2,3,4,6,7,8-octahydro-2,3,8,8-tetramethylnaphthalene, hexyl salicylate, 4-tert-butylcyclohexyl acetate, 2-tert-butylcyclohexyl acetate, alpha-ionone, n-alpha-methylionone, alpha-iso-methylionone, coumarin, terpinyl acetate, 4-(4-hydroxy-4-methylpentyl)-3-cyclohexenecarboxaldehyde, alpha-amylcinnamaldehyde, ethylene brassylate, (E)-3-methylcyclopentadec-5-enone, (Z)-3-methylcyclopentadec-5-enone, 15-pentadec-11-enolide, 15-pentadec-12-enolide, 15-cyclopentadecanolide, 1-(5,6,7,8-tetrahydro-3,5,5,6,8,8-hexamethyl-2-naphthalenyl)ethanone, 2-isobutyl-4-methyltetrahydro-2H-pyran-4-ol, 2-ethyl-4-(2,2,3-trimethyl-3-cyclopenten-1-yl)-2-buten-1-ol, cis-3-hexenyl acetate, trans-3-hexenyl acetate, trans-2/cis-6-nonadienol, 2,4-dimethyl-3-cyclohexenecarboxaldehyde, 2,4,4,7-tetramethyloct-6-en-3-one, 2,6-dimethyl-5-hepten-1-al, borneol, 3-(3-isopropylphenyl)butanal, 2-methyl-3-(3,4-methylenedioxyphenyl)propanal, 3-(4-ethylphenyl)-2,2-dimethylpropanal, 7-methyl-2H-1,5-benzodioxepin-3(4H)-one, 3,3,5-trimethylcyclohexyl acetate (preferably with a content of cis isomers of 70 wt. % or more), 2,5,5-trimethyl-1,2,3,4,4a,5,6,7-octahydronaphthalen-2-ol, 3-(4-tert-butylphenyl)-propanal, ethyl 2-methylpentanoate, ethoxymethoxycyclododecane, 2,4-dimethyl-4,4a,5,9b-tetrahydroindeno[1,2-d][1,3]dioxine, (2-tert-butylcyclohexyl) acetate, 3-[5,5,6-trimethylbicyclo[2.2.1]hept-2-yl]cyclohexan-1-ol, menthone, isomenthone, carvone, beta-n-methylionone, beta-isomethylionone, alpha-irone, alpha-damascone, beta-damascone, delta-damascone, acetylated cedar wood oil, and mixtures thereof.
   E.49. The composition according to any of embodiments E.38 to E.48, which is selected from the group consisting of perfume compositions, body care compositions, products for oral or dental hygiene, hygiene articles, cleaning compositions, textile detergent compositions, compositions for scent dispensers, foods, food supplements, pharmaceutical compositions and crop protection compositions.
   E.50. The composition according to embodiment E.49 which is selected from the group consisting of perfume compositions, body care compositions, products for oral or dental hygiene, hygiene articles, cleaning compositions, textile detergent compositions, compositions for scent dispensers, and crop protection compositions.
   E.51. A method of preparing an aroma chemical composition, comprising incorporating a 1,4-butanediol mono- or diester of the formula (I) or a mixture of different 1,4-butanediol mono- and/or diesters of the formula (I) as defined in any of embodiments E.1 to E.23 into said composition.
   E.52. A method for preparing an aroma chemical composition, comprising mixing a 1,4-butanediol mono- or diester of the formula (I) or a mixture of different 1,4-butanediol mono- and/or diesters of the formula (I) as defined in any of embodiments E.1 to E.23 simultaneously or consecutively with the other components of said composition or with pre-formed mixtures of a part of the other components of said composition.
   E.53. The method according to any embodiments E.51 or E.52, for preparing a fragranced composition.
   E.54. The method according to embodiment E.53, for preparing a fragranced ready-to-use composition.
   E.55. A method for conferring an aroma to a composition by incorporating a 1,4-butanediol mono- or diester of the formula (I) or a mixture of different 1,4-butanediol mono- and/or diesters of the formula (I)) as defined in any of embodiments E.1 to E.23 into said composition, or by mixing a 1,4-butanediol mono- or diester of the formula (I) or a mixture of different 1,4-butanediol mono- and/or diesters of the formula (I) as defined in any of embodiments E.1 to E.23 simultaneously or consecutively with the other components of said composition or with pre-formed mixtures of a part of the other components of said composition.
   E.56. The method according to embodiment E.55, for conferring a fragrance to a composition.
   E.57. The method according to any of embodiments E.55 or E.56, for conferring a fruity or a sweet or a combined fruity and sweet aroma, preferably fragrance, to a composition.
   E.58. The method according to any of embodiments E.55 to E.57, for conferring an aroma to a personal care or homecare composition.
   E.59. A method of modifying and/or enhancing the aroma of a composition, comprising incorporating a 1,4-butanediol mono- or diester of the formula (I) or a mixture of different 1,4-butanediol mono- and/or diesters of the formula (I)) as defined in any of embodiments E.1 to E.23 into a composition, or comprising mixing a 1,4-butanediol mono- or diester of the formula (I) or a mixture of different 1,4-butanediol mono- and/or diesters of the formula (I) as defined in any of embodiments E.1 to E.23 simultaneously or consecutively with the other components of said composition or with pre-formed mixtures of a part of the other components of said composition.
   E.60. The method according to embodiment E.59, for modifying and/or enhancing the fragrance impression of a fragranced composition, comprising incorporating a 1,4-butanediol mono- or diester of the formula (I) or a mixture of different 1,4-butanediol mono- and/or diesters of the formula (I)) as defined in any of embodiments E.1 to E.23 into a fragranced composition, or comprising mixing a 1,4-butanediol mono- or diester of the formula (I) or a mixture of different 1,4-butanediol mono- and/or diesters of the formula (I) as defined in any of embodiments E.1 to E.23 simultaneously or consecutively with the other components of said composition or with pre-formed mixtures of a part of the other components of said composition.
   E.61. The method according to embodiment E.60, for modifying and/or enhancing the fragrance impression of a fragranced ready-to-use composition, comprising incorporating a 1,4-butanediol mono- or diester of the formula (I) or a mixture of different 1,4-butanediol mono- and/or diesters of the formula (I)) as defined in any of embodiments E.1 to E.23 into a ready-to-use fragranced composition.
   E.62. The method according to any of embodiments E.60 or E.61, for modifying the scent character of a fragranced composition.

The companies from which the above-listed aroma chemical compounds identified by tradenames and indices can be obtained are listed below.

In a preferred embodiment, a 1,4-butanediol diester is used, i.e. a compound (I) wherein R¹ is —C(═O)—R³. In such diesters, R² and R³ are preferably identical, yet out of practical reasons (simpler synthesis and purification), but also for making it easier and more economic to provide a reproducible aroma impression.

In another preferred embodiment, a mixture of a 1,4-butanediol diester (i.e. a compound (I) wherein R¹ is —C(═O)—R³) and a 1,4-butanediol monoester ((i.e. a compound (I) wherein R¹ is hydrogen) is used. In such mixtures, too, it is preferred that R² and R³ in the diester and R² in the monoester are identical; i.e. mono- and diester are derived from the same (and just one) carboxylic acid.

More preferably, R¹ is hydrogen or —C(═O)—CH₃; and R² is methyl.

Thus, in one more preferred embodiment, 1,4-butanediol diacetate is used.

In another more preferred embodiment, of a mixture of 1,4-butanediol diacetate and 1,4-butanediol monoacetate is used.

In another preferred embodiment, R¹ is hydrogen or —C(═O)—CH₂CH₃; and R² is ethyl. Thus, in one preferred embodiment, 1,4-butanediol dipropionate is used. In another preferred embodiment, a mixture of 1,4-butanediol dipropionate and 1,4-butanediol monopropionate is used.

More preference is however given to 1,4-butanediol diacetate and mixtures of 1,4-butanediol diacetate and 1,4-butanediol monoacetate.

If a mixture containing a 1,4-butanediol diester and a 1,4-butanediol monoester is used, e.g. the above preferred mixture of 1,4-butanediol diacetate and 1,4-butanediol monoacetate, or the mixture of 1,4-butanediol dipropionate and 1,4-butanediol monopropionate, the mixture contains the 1,4-butanediol monoester in an amount of preferably from 0.1 to 99% by weight. Since however the diester generally has the more intensive odor and is less polar, which brings about advantages in the formulation, it is preferred that the diester be the predominating component in the mono-/diester mixture, i.e. be present in an amount of more than 50% by weight, relative to the overall weight of the 1,4-butanediol diester and the 1,4-butanediol monoester. Thus, more preferably, the mixture contains the 1,4-butanediol monoester in an amount of from 0.1 to <50% by weight, e.g. from 0.1 to 30% by weight; more preferably from 0.1 to 20% by weight, even more preferably from 0.1 to 10% by weight, in particular from 0.1 to 5% by weight, more particularly from 0.1 to 2% by weight, specifically from 0.1 to 1% by weight and very specifically from 0.1 to 0.5% by weight, relative to the overall weight of the 1,4-butanediol diester and the 1,4-butanediol monoester.

The 1,4-butanediol mono- and diesters of the formula (I) are known substances and are either commercially available or can be prepared by standard proceedings, e.g. by esterification of 1,4-butanediol with acetic acid/and or propionic acid (R²—C(═O)OH/R³—C(═O)OH), or with more active derivatives thereof, such as the acid halides (e.g. the chloride or bromide), anhydrides or active esters thereof under typical esterification conditions, if desired under removal of the reaction water formed (if the acid as such is used) or of the acid formed (if an anhydride is used) to enhance the reaction rate, or under neutralization (if an acid halide is used).

The esterification can be carried out in the presence of an esterification catalyst; this is especially indicated if the carboxylic acid as such is used. Suitable esterification catalysts are well known in the art and are for example metal based catalysts, e.g. iron, cadmium, cobalt, lead, zinc, antimony, magnesium, titanium and tin catalysts in the form of metals, metal oxides or metal salts, such as metal alkoxylates; or acids, e.g. mineral acids, such as sulfuric acid, hydrochloric acid or phosphoric acid; organic sulfonic acids, such as methane sulfonic acid or para-toluene sulfonic acid or strongly acidic cation exchange resins.

The term “strongly acidic cationic exchanger” refers to a cationic exchanger in the H+ form which has strongly acidic groups. The strongly acidic groups are generally sulfonic acid groups; they are generally bonded to a polymer matrix, which can be e.g. gel-like and/or macroporous. Preference is given to styrene (co)polymers containing sulfonic acid groups, specifically to styrene-divinyl benzene copolymers containing sulfonic acid groups. Commercial examples for such cationic exchangers are Lewatit® (Lanxess), Purolite® (The Purolite Company), Dowex® (Dow Chemical Company), Amberlite® (Rohm and Haas Company), Amberlyst® (Rohm and Haas Company). Preferred strongly acidic cation exchangers are: Lewatit® K 1221, Lewatit® K 1461, Lewatit® K 2431, Lewatit® K 2620, Lewatit® K 2621, Lewatit® K 2629, Lewatit® K 2649, Amberlite® FPC 22, Amberlite® FPC 23, Amberlite® IR 120, Amberlyst® 131, Amberlyst® 15, Amberlyst® 31, Amberlyst® 35, Amberlyst® 36, Amberlyst® 39, Amberlyst® 46, Amberlyst® 70, Purolite® SGC650, Purolite® C100H, Purolite® C150H, Dowex® 50×8, Serdolit® red and Nafion® NR-50. Alternatively, the cation exchanger can be a perfluorinated ion exchange resin, sold e.g. under the Nation® brand of DuPont.

The esterification can be carried out in the presence of a base; this is especially indicated if a carboxylic acid halide is used. Suitable bases are for example organic bases, such as tertiary amines, e.g. trimethylamine, triethylamine, tripropylamine, ethyldiisopropylamine and the like, or basic N-heterocycles, such as morpholine, pyridine, lutidine, DMAP, DABCO, DBU or DBN.

For the preparation of the diester, 1,4-butanediol is typically reacted with at least two equivalents, e.g. with 2 to 4 mol, of acetic acid (or a derivative thereof) and/or propionic acid (or a derivative thereof) or a mixture thereof per mol of 1,4-butanediol.

For the preparation of the monoester, 1,4-butanediol is typically reacted with at most one equivalent of acetic acid (or a derivative thereof) and/or propionic acid (or a derivative thereof) or a mixture thereof per mol of 1,4-butanediol. Even if these mol ratios are used, the diester is in most cases nevertheless formed alongside the monoester. Therefore, a separation step is required if the pure monoester or mixtures with less diester are desired. Separation can be carried out by usual means, such as distillative, extractive or chromatographic methods.

The reaction can be carried out in a solvent or neat.

After completion of the reaction, the esterification product can be isolated by usual means, if necessary after neutralization (especially if an acid halide or anhydride was used as starting material or if the acid was used in excess) and/or removal of the catalyst (especially if this is solid, e.g. one of the above-mentioned metal based catalysts or ionic exchange resins), for example by distillative, extractive or chromatographic methods. If desired, the isolated product can subsequently be further purified.

1,4-Butanediol is a commercially available commodity substance and can be prepared, for example, via the Reppe process from acetylene and formaldehyde with subsequent hydrogenation of the intermediate 2-butyn-1,4-diol, or via the Davy process from maleic anhydride.

In a preferred embodiment, however, the 1,4-butanediol mono- or diester of the formula (1) or the mixture of different 1,4-butanediol mono- and/or diesters of the formula (I) is derived from a renewable source. To be more specific, at least the alcohol part of the esters, i.e. 1,4-butanediol, is derived from a renewable source. More preferably, both the alcohol part of the esters, i.e. 1,4-butanediol, and the carboxylic acid part of the esters, i.e. the R²—C(═O)— moiety and the R³—C(═O)— moiety (if R¹ is —C(═O)—R³ and if R²≠R³), are derived from a renewable source.

1,4-Butanediol prepared from renewable sources is commercially available. Known methods start for example from furfural (furan-2-aldehyde), which is in turn obtained from carbohydrates, for example from pentoses contained in many plant materials (most often agricultural byproducts like sugarcane bagasse and corn cobs are used) which are dehydrated with sulfuric acid. The production of wood pulp with the magnesium bisulfite process also yields high amounts of furfural. Furfural can be converted to furan, which can be hydrogenated and ring-opened to 1,4-butanediol. Alternatively, succinic acid or polyhydroxy butyric acid obtained from fermentation processes can be hydrogenated to 1,4-butanediol, either directly or via γ-butyrolactone and THF. Succinic acid can be obtained from fermentation (using e.g. various bacterial strains) of biomass, e.g. from sugars (e.g. sucrose, raffinose, fructose, glucose, galactose, lactose, mannose, xylose, arabinose) or glycerol (obtained in turn from vegetable/animal oils or fats). Also the direct fermentation of sugars can give 1,4-butanediol.

The carboxylic acids on which the R²—C(═O)— moiety and the R³—C(═O)— moiety, if present, are based, are found abundantly in nature. Acetic acid, for instance, can be obtained from the oxidation of ethanol which can in turn be obtained from the fermentation of any sugar- or starch-containing crop, such as fruits and cereals.

The origin of the 1,4-butanediol or its ester from a renewable source can be verified, for example, by radiocarbon dating. Radiocarbon dating is based on the fact that radiocarbon (¹⁴C) is constantly created in the earth's atmosphere by the interaction of cosmic rays with atmospheric nitrogen: The cosmic rays generate neutrons in the atmosphere which can strike nitrogen-14 (¹⁴N) atoms. These, in turn, decay to ¹⁴C under release of a proton. The resulting ¹⁴C combines with atmospheric oxygen to form radioactive carbon dioxide, which is incorporated into plants by photosynthesis, subsequently into herbivorous animals feeding on plants and ultimately into the complete biosphere by carnivorous animals feeding on herbivorous animals. Upon death of the animal or plant, carbon exchange with its environment is stopped, whereupon the amount of ¹⁴C begins to decrease as the ¹⁴C undergoes radioactive decay.

Measuring the amount of ¹⁴C in a 1,4-butanediol or 1,4-butanediol ester sample is thus an indicator of its origin: In 1,4-butanediol in which the 1,4-butanediol is from a renewable source, the amount of ¹⁴C will be the same or not essentially lower than found in presently living organisms.

Generally, the molar ratio of the ¹²C isotope to the ¹⁴C isotope is used as an indicator. In living organisms, the molar ratio of the ¹²C isotope to the ¹⁴C isotope is approximately 1×10¹²: 1 (to be more precise 1×10¹²: 1.25).

Thus, the content of the ¹⁴C isotope in the 1,4-butanediol ester will be at a detectable level if at least part of the 1,4-butanediol mono- or diester of the formula (I) or the mixture of different 1,4-butanediol mono- and/or diesters of the formula (I) is derived from a renewable source. Suitable methods for determining the content of the ¹⁴C isotope are known in the art and deliver generally comparable results. For example, the method according to ASTM D6866-21 can be used; this method was specifically developed for determining the content of bio-based/biogenic carbon in bioproducts. However, other methods are suitable as well. The detection level of the available methods of the content of the ¹⁴C isotope is such that it allows radiocarbon dating between ca. 300 and 60000 before the present time, which is very remote from the age of fossil carbon sources. Thus, any detected ¹⁴C isotope is an indicator of a renewable origin of the 1,4-butanediol esters.

In a preferred embodiment, the molar ratio of the ¹²C isotope to the ¹⁴C isotope in the 1,4-butanediol ester is less than 3×10¹²: 1, i.e. it is from ca. 1×10¹²: 1 (to be more precise from 1×10¹²: 1.25) to less than 3×10¹²: 1.

In another preferred embodiment, the molar ratio of the ¹²C isotope to the ¹⁴C isotope in 1,4-butanediol on which the esters are based is less than 2×10¹²: 1, i.e. it is from ca. 1×10¹²: 1 (to be more precise from 1×10¹²: 1.25) to less than 2×10¹²: 1.

In another preferred embodiment, the 1,4-butanediol mono- or diester of the formula (I) or the mixture of different 1,4-butanediol mono- and/or diesters of the formula (I) is derived from upcycling C₁ “exhaust gases” which would otherwise be released into the atmosphere, such as CO₂ or methane. CO₂, for instance, can be sequestered from power plants or factories and converted into products of value, such as acetic acid, which can be used in the synthesis of the present 1,4-butanediol mono- or diester of the formula (I). Alternatively, the sequestered CO₂ can be reacted with acetylene to acetylenedicarboxylic acid which is subsequently hydrogenated to 1,4-butanediol (in general, the triple bond is hydrogenated, the resulting succinic acid or alkali metal succinate is esterified with methanol to dimethyl succinate and this is then hydrogenated to 1,4-butanediol). In yet another embodiment, 1,4-butanediol can be produced classically from acetylene and formaldehyde, where formaldehyde is obtained from direct reduction of sequestered CO₂ or in a reduction-oxidation sequence of sequestered CO₂ via methanol, or is obtained from the oxidation of sequestered methane via methanol. Methane, for instance, can be sequestered from ruminant stables, but also from biomass burning and power plants.

Alternatively, the 1,4-butanediol mono- and diesters of the formula (I) can be prepared by reacting acetic acid/and or propionic acid with a compound X—(CH₂)₄—Y, wherein X represents a leaving group selected from halogen, such as Cl, Br, I, and sulfonates, such as tosylate, mesylate, triflate or nonaflate, and Y has either the same meaning as X (for preparing a diester) or is a protected OH group (e.g. protected by one of the usual silyl protective groups, such as TMS, TES, TBDMS, TIPS or TBDPS; for preparing the monoester), typically in the presence of a base, so that the acetate or propionate is the actual nucleophile. Suitable bases are those listed above. Alternatively, instead of acetic acid/and or propionic acid, an acetate and/or propionate and no further base is used, generally an alkali metal acetate and/or propionate, e.g. sodium or potassium acetate and/or propionate. If Y is a protected OH group, the compound is deprotected after completion of the esterification reaction, e.g. with HF or pyridiumhydrofluoride. Compounds X—(CH₂)₄—Y are commercially available or can be prepared by standard reactions. They can for example be obtained from 1,4-butanediol and are thus also obtainable from a renewable source or from upcycling C₁ exhaust gases.

Preferably, the 1,4-butanediol mono- or diester of the formula (I) or the mixture of two or more different 1,4-butanediol mono- or diesters of the formula (I) is used for imparting an olfactory impression. In particular, the 1,4-butanediol mono- or diester of the formula (I) or the mixture of two or more different 1,4-butanediol mono- or diesters of the formula (I) is used as a fragrance.

In particular, the 1,4-butanediol mono- or diester of the formula (I) or the mixture of two or more different 1,4-butanediol mono- or diesters of the formula (I) is used for imparting a fruity or sweet or combined fruity and sweet olfactory note.

Specifically, 1,4-butanediol diacetate or a mixture of 1,4-butanediol diacetate and 1,4-butanediol monoacetate containing 0.1 to 20% by weight, e.g. 0.1 to 10% by weight or 0.1 to 5% by weight or 0.1 to 2% by weight or 0.1 to 1% by weight or 0.1 to 0.5% by weight, of 1,4-butanediol monoacetate, relative to the overall weight of 1,4-butanediol diacetate and 1,4-butanediol monoacetate, is used for imparting one of the following olfactory notes: red fruit, raspberry, blueberry, sweet; or any combination thereof. The fruity impression increases with increasing monoacetate content.

Specifically, 1,4-butanediol dipropionate or a mixture of 1,4-butanediol dipropionate and 1,4-butanediol monopropionate containing 0.1 to 10% by weight, preferably 0.1 to 5% by weight, specifically 0.1 to 3% by weight of 1,4-butanediol monopropionate, relative to the overall weight of 1,4-butanediol dipropionate and 1,4-butanediol monopropionate, is used for imparting one of the following olfactory notes: red fruit, raspberry, blueberry, sweet; or any combination thereof.

The 1,4-butanediol mono- or diester of the formula (I) or the mixture of two or more different 1,4-butanediol mono- or diesters of the formula (I) is generally used in a ready-to-use composition, in particular in a fragranced ready-to-use composition. “Fragranced ready-to-use composition”, as used herein, refers to a ready-to-use composition which predominately induces a pleasant odor impression.

The 1,4-butanediol mono- or diester of the formula (I) or the mixture of different 1,4-butanediol mono- and/or diesters of the formula (I) is also used for modifying and/or enhancing the aroma of a composition; in particular for modifying and/or enhancing the fragrance impression of a composition; specifically for modifying the scent character of a fragranced ready-to-use composition.

Fragranced ready-to-use compositions are for example compositions used in personal care, in homecare, in industrial applications as well as compositions used in other applications, such as pharmaceutical compositions or crop protection compositions. Among these, preference is given to personal care and homecare compositions.

Personal care compositions encompass body care compositions, products for oral or dental hygiene and hygiene articles for use on the human body.

Personal care compositions are used for cleaning, washing, disinfecting, nurturing, grooming, protecting or embellishing the human body (and thus also include cosmetics). Examples are creams, lotions, ointments, other o/w or w/o emulsions, liquid or gel-like soaps, shower gels, shampoos, make-up and other decorative cosmetics, and compositions for wet wipes (e.g. for cleaning the nappy area). More specific examples are skin-washing and cleansing preparations in the form of soaps, syndets, washing gels, soapless detergents or washing pastes, bath preparations, e.g. foam baths, milks, oils, shower preparations; skin-care preparations, e.g. skin emulsions, multi-emulsions, powders, sprays or skin oils; cosmetic preparations, e.g. facial make-up in the form of day creams or powder creams, face powder (loose or pressed), rouge or cream make-up, eye-care preparations, e.g. eyeshadow preparations, mascara, eyeliner, eye creams or eye-fix creams; lip-care preparations, e.g. lipsticks, lip gloss, lip contour pencils, nail-care preparations, such as nail varnish, nail varnish removers, nail hardeners or cuticle removers; foot-care preparations, e.g. foot baths, foot powders, foot creams or foot balsams, special deodorants and antiperspirants or callus-removing preparations; light-protective preparations, such as sun milks, lotions, creams or oils, sunblocks or tropicals, pre-tanning preparations or after-sun preparations; skin-tanning preparations, e.g. self-tanning creams; depigmenting preparations, e.g. preparations for bleaching the skin or skin-lightening preparations; insect-repellents, e.g. insect-repellent oils, lotions, sprays or sticks; deodorants, such as deodorant sprays, deodorant aerosols, pump-action sprays, deodorant gels, sticks or roll-ons, also water-free deodorant aerosols or sticks; antiperspirants, e.g. antiperspirant sticks, creams or roll-ons; preparations for cleansing and caring for blemished skin, e.g. synthetic detergents (solid or liquid), peeling or scrub preparations or peeling masks; hair-removal preparations in chemical form (depilation), e.g. liquid hair-removing preparations, cream- or paste-form hair-removing preparations, hair-removing preparations in gel form or aerosol foams; shaving preparations, e.g. shaving soap, foaming shaving creams, non-foaming shaving creams, foams and gels, pre-shave preparations for dry shaving, aftershaves or aftershave lotions; fragrance preparations, e.g. fragrances (eau de Cologne, eau de toilette, eau de parfum, parfum de toilette, perfume), perfume oils or perfume creams; cosmetic hair-treatment preparations, e.g. hair-washing preparations in the form of shampoos and conditioners, hair-care preparations, e.g. pre-treatment preparations, hair tonics, styling creams, styling gels, pomades, hair rinses, treatment packs, intensive hair treatments, hair-structuring preparations, e.g. hair-waving preparations for permanent waves (hot wave, mild wave, cold wave), hair-straightening preparations, liquid hairsetting preparations, hair foams, hairsprays, bleaching preparations, e.g. hydrogen peroxide solutions, lightening shampoos, bleaching creams, bleaching powders, bleaching pastes or oils, temporary, semi-permanent or permanent hair colorants, preparations containing self-oxidising dyes, or natural hair colorants, such as henna or camomile; antidandruff preparations in the form of shampoos, conditioners, hair tonics, styling creams or gels or treatments packs; oral care preparations such as (tooth) pastes, gels, mouth washes and sprays; disinfectants for mouth or skin. Further examples are given below.

Examples for homecare compositions are dishwashing compositions, laundry compositions (for example laundry detergents, fabric softeners, rinsing compositions, bleacher compositions, stain remover compositions and the like), surface cleaning compositions (also termed hard surface cleaners; for example glass, floor, counter, bath(room), toilet bowl, sink, kitchen, appliance and furniture cleaning compositions; all-purpose cleaners; sanitary cleaners), non-cosmetic deodorants (e.g. air and/or surface deodorants), disinfectants (for example spray air disinfectants, and spray, liquid and paste/gel surface disinfectants), surface protecting and/or polishing compositions, rug shampoos, descaling agents, and compositions for wet wipes (e.g. for cleaning the floor, furniture, bath room surfaces etc.).

Compositions in industrial applications are for example compositions for cleaning or disinfecting on an industrial scale (also called industrial and institutional cleaning or I&I cleaning) or clean-in-place (CIP) composition (CIP is a method of automated cleaning the interior surfaces of pipes, vessels, equipments, filters and associated fittings and the like without major disassembly).

Crop protection compositions, which are often also termed plant protection compositions, are compositions which are effective against various harmful microorganisms, harmful invertebrate pests or undesired plants relevant for agriculture, e.g. harmful fungi, harmful invertebrate pests, such as harmful insects, arachnids, nematodes or molluscs, and weeds, which cause damage to agricultural plants, plant propagation materials, such as seeds, or harvested crops. Examples for crop protection compositions are fungicidal, insecticidal, acaricidal, nematicidal, moluscicidal or herbicidal compositions. The term encompasses also plant growth regulating compositions. Plant growth regulators are plant protection products used to influence plant growth and are used, for example, for increasing the stability of cereals by shortening the stalk length, thus reducing or preventing lodging, for improving the rooting of cuttings, reducing plant height in horticulture, preventing the germination of potatoes and the like. The term encompasses moreover compositions used in material protection for combating various harmful microorganisms and invertebrate pests, such as compositions for the treatment of lumber or the surroundings of lumber material against termites or compositions of the treatment of mosquito nets against harmful insects, such as Anopheles mosquitoes, and the like.

Preferably, the 1,4-butanediol mono- or diester of the formula (I) or the mixture of two or more different 1,4-butanediol mono- or diesters of the formula (I) is used in a composition selected from the group consisting of perfume compositions, body care compositions (including cosmetic compositions), products for oral and dental hygiene, hygiene articles, cleaning compositions (including dishwashing compositions), textile detergent compositions, compositions for scent dispensers, foods, food supplements, pharmaceutical compositions and crop protection compositions; and preferably from perfume compositions, body care compositions, products for oral or dental hygiene, hygiene articles, cleaning compositions, textile detergent compositions, compositions for scent dispensers, and crop protection compositions.

In particular, the 1,4-butanediol mono- or diester of the formula (I) or the mixture of two or more different 1,4-butanediol mono- or diesters of the formula (I) is used to impart a fruity or sweet or combined fruity and sweet olfactory note to the above-listed compositions.

Specifically, 1,4-butanediol diacetate or a mixture of 1,4-butanediol diacetate and 1,4-butanediol monoacetate containing 0.1 to 20% by weight, e.g. 0.1 to 10% by weight or 0.1 to 5% by weight or 0.1 to 2% by weight or 0.1 to 1% by weight or 0.1 to 0.5% by weight, of 1,4-butanediol monoacetate, relative to the overall weight of 1,4-butanediol diacetate and 1,4-butanediol monoacetate, is used to impart one of the following olfactory notes: red fruit, raspberry, blueberry, sweet; or any combination thereof to the above-listed compositions. The fruity impression increases with increasing monoacetate content.

Specifically, 1,4-butanediol dipropionate or a mixture of 1,4-butanediol dipropionate and 1,4-butanediol monopropionate containing 0.1 to 10% by weight, preferably 0.1 to 5% by weight, specifically 0.1 to 3% by weight of 1,4-butanediol monopropionate, relative to the overall weight of 1,4-butanediol dipropionate and 1,4-butanediol monopropionate, is used to impart one of the following olfactory notes: red fruit, raspberry, blueberry, sweet; or any combination thereof to the above-listed compositions.

Details to the above-listed compositions are given below.

In addition to the olfactory properties, the 1,4-butanediol mono- or diester of the formula (I) or the mixture of two or more different 1,4-butanediol mono- or diesters of the formula (I) exhibit advantageous secondary properties.

For example, they can provide better sensory profiles as a result of synergistic effects with other fragrances, which means that they can provide a booster effect for other fragrances. They are therefore suitable as boosters for other fragrances.

Accordingly, another aspect of the invention relates to the use of the 1,4-butanediol mono- or diester of the formula (I) or the mixture of two or more different 1,4-butanediol mono- or diesters of the formula (I) for modifying the scent character of a fragranced composition; and specifically to the use as a booster for other fragrances.

Booster effect means that the substances enhance and intensify in perfumery formulations the overall impression of the mixture. In the mint range, for example, it is known that menthyl methyl ether intensifies the perfumery or taste mixtures of peppermint oils and particularly in top notes brings about a considerably more intensive and more complex perception although the ether itself, being a pure substance, develops no particular intensive odor at all. In fragrance applications, Hedione® (methyl dihydrojasmonate), which as a pure substance only exhibits a light floral jasmin-note, reinforces diffusion, freshness and volume of a perfume composition as an odor booster. Booster effects are particularly desired when top-note-characterized applications are required, in which the odor impression is to be conveyed particularly quickly and intensively, for example in deodorants, air fresheners or in the taste sector in chewing gums.

To achieve such a booster effect, the 1,4-butanediol mono- or diester of the formula (I) or the mixture of two or more different 1,4-butanediol mono- or diesters of the formula (I) are generally used in an amount of 0.1 to 20% by weight, preferably in an amount of 0.5 to 10% by weight, in particular in an amount of from 0.6 to 5% by weight, based on the total weight of the fragrance mixture.

Furthermore, the 1,4-butanediol mono- or diester of the formula (I) or the mixture of two or more different 1,4-butanediol mono- or diesters of the formula (I) can have further positive effects on the composition in which they are used. For example, they can enhance the overall performance of the composition into which they are incorporated, such as the stability, e.g. the formulation stability, the extendability or the staying power of the composition.

A further embodiment of the invention is directed to a method of preparing an aroma chemical composition, in particular a fragranced composition, especially a fragranced ready-to-use composition, comprising incorporating at a 1,4-butanediol mono- or diester of the formula (I) or a mixture of two or more different 1,4-butanediol mono- or diesters of the formula (I) into the target composition, e.g. a ready-to-use composition, resulting in an aroma chemical composition, in particular in a fragranced composition, especially in a fragranced ready-to-use composition. Alternatively, the invention is directed to a method of preparing an aroma chemical composition, in particular a fragranced composition, especially a fragranced ready-to-use composition, comprising mixing the 1,4-butanediol mono- or diester of the formula (I) or the mixture of two or more different 1,4-butanediol mono- or diesters of the formula (I) with at least one aroma chemical different from compounds (I) and/or with at least one non-aroma chemical carrier and/or with at least one antioxidant and/or with at least one deodorant-active agent. Suitable and preferred aroma chemicals different from compounds (I), non-aroma chemical carriers, antioxidants and deodorant-active agents are described below. Alternatively, the invention is directed to a method of preparing an aroma chemical composition, in particular a fragranced composition, especially a fragranced ready-to-use composition, comprising mixing the 1,4-butanediol mono- or diester of the formula (1) or the mixture of two or more different 1,4-butanediol mono- and/or diesters of the formula (I) simultaneously or consecutively with the other components of said composition or with pre-formed mixtures of a part of the other components of said composition.

For example, the method can be carried out by mixing the 1,4-butanediol mono- or diester of the formula (I) or the mixture of two or more different 1,4-butanediol mono- or diesters of the formula (I), as defined above, and at least one further component selected from the group consisting of aroma chemicals different from compounds (I), non-aroma chemical carriers, antioxidants and deodorant-active agents.

The invention is also directed to a method for modifying the scent character of an aroma chemical composition, in particular of a fragranced composition, especially of a fragranced ready-to-use composition, comprising incorporating the 1,4-butanediol mono- or diester of the formula (I) or the mixture of two or more different 1,4-butanediol mono- or diesters of the formula (I) into an aroma chemical composition, in particular into a fragranced composition, especially into a fragranced ready-to-use composition. Alternatively, the invention is directed to a method for modifying the scent character of an aroma chemical composition, in particular of a fragranced composition, especially of a fragranced ready-to-use composition, comprising mixing the 1,4-butanediol mono- or diester of the formula (I) or the mixture of two or more different 1,4-butanediol mono- and/or diesters of the formula (I) simultaneously or consecutively with the other components of said composition or with pre-formed mixtures of a part of the other components of said composition.

In particular, the invention is directed to a method of preparing a perfume composition, body care composition, product for oral and dental hygiene, hygiene article, cleaning composition, textile detergent composition, composition for scent dispensers, food, food supplement, pharmaceutical composition or crop protection composition, comprising including the 1,4-butanediol mono- or diester of the formula (I) or the mixture of two or more different 1,4-butanediol mono- or diesters of the formula (I) as defined above in a perfume composition, body care composition, product for oral and dental hygiene, hygiene article, cleaning composition, textile detergent composition, composition for scent dispensers, food, food supplement, pharmaceutical composition or crop protection composition. Alternatively, the invention is directed to a method of preparing a perfume composition, body care composition, product for oral and dental hygiene, hygiene article, cleaning composition, textile detergent composition, composition for scent dispensers, food, food supplement, pharmaceutical composition or crop protection composition, comprising mixing the 1,4-butanediol mono- or diester of the formula (I) or the mixture of two or more different 1,4-butanediol mono- and/or diesters of the formula (I) simultaneously or consecutively with the other components of said composition or with pre-formed mixtures of a part of the other components of said composition.

In a particular embodiment the invention is directed to a method for imparting a fruity or sweet or combined fruity and sweet note to a perfume composition, body care composition, product for oral and dental hygiene, hygiene article, cleaning composition, textile detergent composition, composition for scent dispensers, food, food supplement, pharmaceutical composition or crop protection composition, which comprises including the 1,4-butanediol mono- or diester of the formula (I) or the mixture of two or more different 1,4-butanediol mono- or diesters of the formula (I) in a perfume composition, body care composition, product for oral and dental hygiene, hygiene article, cleaning composition, textile detergent composition, composition for scent dispensers, food, food supplement, pharmaceutical composition or crop protection composition. Alternatively, the invention is directed to a method for imparting a fruity or sweet or combined fruity and sweet note to a perfume composition, body care composition, product for oral and dental hygiene, hygiene article, cleaning composition, textile detergent composition, composition for scent dispensers, food, food supplement, pharmaceutical composition or crop protection composition, comprising mixing the 1,4-butanediol mono- or diester of the formula (I) or the mixture of two or more different 1,4-butanediol mono- and/or diesters of the formula (I) simultaneously or consecutively with the other components of said composition or with pre-formed mixtures of a part of the other components of said composition.

In a particular embodiment the invention is directed to a method for imparting one of the olfactory notes: red fruit, raspberry, blueberry, sweet; or any combination thereof to a perfume composition, body care composition, product for oral and dental hygiene, hygiene article, cleaning composition, textile detergent composition, composition for scent dispensers, food, food supplement, pharmaceutical composition or crop protection composition, which comprises including 1,4-butanediol diacetate or a mixture of 1,4-butanediol diacetate and 1,4-butanediol monoacetate containing 0.1 to 20% by weight, e.g. 0.1 to 10% by weight or 0.1 to 5% by weight or 0.1 to 2% by weight or 0.1 to 1% by weight or 0.1 to 0.5% by weight, of 1,4-butanediol monoacetate, relative to the overall weight of 1,4-butanediol diacetate and 1,4-butanediol monoacetate, in a perfume composition, body care composition, product for oral and dental hygiene, hygiene article, cleaning composition, textile detergent composition, composition for scent dispensers, food, food supplement, pharmaceutical composition or crop protection composition. The fruity impression increases with increasing monoacetate content. In another particular embodiment the invention is directed to a method for imparting one of the olfactory notes: red fruit, raspberry, blueberry, sweet; or any combination thereof to a perfume composition, body care composition, product for oral and dental hygiene, hygiene article, cleaning composition, textile detergent composition, composition for scent dispensers, food, food supplement, pharmaceutical composition or crop protection composition, which comprises including 1,4-butanediol dipropionate or a mixture of 1,4-butanediol dipropionate and 1,4-butanediol monopropionate containing 0.1 to 10% by weight, preferably 0.1 to 5% by weight, specifically 0.1 to 3% by weight of 1,4-butanediol monopropionate, relative to the overall weight of 1,4-butanediol dipropionate and 1,4-butanediol monopropionate, in a perfume composition, body care composition, product for oral and dental hygiene, hygiene article, cleaning composition, textile detergent composition, composition for scent dispensers, food, food supplement, pharmaceutical composition or crop protection composition.

### Compositions

The invention relates moreover to a composition comprising a 1,4-butanediol mono- or diester of the formula (I) or a mixture of different 1,4-butanediol mono- and/or diesters of the formula (I) as defined above, and at least one further component selected from the group consisting of aroma chemicals different from compounds (I), non-aroma chemical carriers, anti-oxidants and deodorant-active agents.

The non-aroma chemical carriers, anti-oxidants and deodorant-active agents are of course also different from compounds (I).

The aroma chemicals different from compounds (I), non-aroma chemical carriers, anti-oxidants and deodorant-active agents are different from the direct precursors from which the 1,4-butanediol mono- or diesters of the formula (I) are prepared; i.e. they are not 1,4-butane diol nor any acid R²—C(═O)OH or R³—C(═O)OH or acid derivative thereof (such as the respective acid anhydride, acid halide or active acid ester) nor a compound X—(CH₂)₄—Y.

The non-aroma chemical carrier is in particular selected from the group consisting of surfactants, oil components (emollients) and solvents.

Thus, in a preferred embodiment, the composition comprises a 1,4-butanediol mono- or diester of the formula (I) or a mixture of different 1,4-butanediol mono- and/or diesters of the formula (I) as defined above, and at least one further component selected from the group consisting of aroma chemicals different from compounds (I), surfactants, oil components, solvents, anti-oxidants and deodorant-active agents.

The pleasant aroma, low volatility and excellent solubility make compounds (I) suitable components in compositions where a pleasing aroma is desirable.

Accordingly, said composition is preferably an aroma chemical composition, more preferably an odor composition and in particular a fragrance composition.

One embodiment of the invention is directed to a composition comprising a 1,4-butanediol mono- or diester of the formula (I) or a mixture of different 1,4-butanediol mono- and/or diesters of the formula (I) as defined above and at least one further component selected from the group consisting of oil components, solvents, anti-oxidants and deodorant-active agents.

One embodiment of the invention is directed to a composition comprising a 1,4-butanediol mono- or diester of the formula (I) or a mixture of different 1,4-butanediol mono- and/or diesters of the formula (I) and at least one aroma chemical.

One embodiment of the invention is directed to a composition comprising a 1,4-butanediol mono- or diester of the formula (I) or a mixture of different 1,4-butanediol mono- and/or diesters of the formula (I) and at least one non-aroma chemical carrier.

One embodiment of the invention is directed to a composition comprising a 1,4-butanediol mono- or diester of the formula (I) or a mixture of different 1,4-butanediol mono- and/or diesters of the formula (I) and at least one surfactant.

One embodiment of the invention is directed to a composition comprising a 1,4-butanediol mono- or diester of the formula (I) or a mixture of different 1,4-butanediol mono- and/or diesters of the formula (I) and at least one oil component.

One embodiment of the invention is directed to a composition comprising a 1,4-butanediol mono- or diester of the formula (I) or a mixture of different 1,4-butanediol mono- and/or diesters of the formula (I) and at least one solvent.

One embodiment of the invention is directed to a composition comprising a 1,4-butanediol mono- or diester of the formula (I) or a mixture of different 1,4-butanediol mono- and/or diesters of the formula (I) and at least one anti-oxidant.

One embodiment of the invention is directed to a composition comprising a 1,4-butanediol mono- or diester of the formula (I) or a mixture of different 1,4-butanediol mono- and/or diesters of the formula (I) and at least one deodorant-active agent.

The 1,4-butanediol mono- or diester of the formula (I) or the mixture of different 1,4-butanediol mono- and/or diesters of the formula (I) can preferably be used in aroma compositions. In preferred embodiments, the aroma composition is an odor composition, i.e. a composition inducing an odor impression, and is in particular a fragrance composition, i.e. a composition inducing a pleasant odor.

The composition according to the invention can be selected from, but is not limited to, the group consisting of perfume compositions, body care compositions (including cosmetic compositions), products for oral and dental hygiene, hygiene articles, cleaning compositions (including dishwashing compositions), textile detergent compositions, compositions for scent dispensers, foods, food supplements, pharmaceutical compositions and crop protection compositions. Preferably, the composition according to the invention is not an alcoholic beverage (and especially not a wine), a fruit juice (and especially not grape juice either unfermented on in a fermentation state toward wine), a fruit (such as a wine grape, a melon or a pineapple) or a seed; moreover, the composition does not comprise diacetyl; and does not comprise 1,3-bis(caprolactam-1-yl)butane.

Preferably, the composition according to the invention is selected from the group consisting of perfume compositions, body care compositions (including cosmetic compositions), products for oral and dental hygiene, hygiene articles, cleaning compositions (including dishwashing compositions), textile detergent compositions, compositions for scent dispensers, and crop protection compositions.

### Aroma Chemicals (Different From Compounds (I)

By virtue of the physical properties of the compounds (I), combinations of said compounds have particularly good, virtually universal solvent properties for and in aroma chemicals and other customary ingredients in aroma compositions such as, in particular, fragrance compositions. Therefore, the 1,4-butanediol mono- or diester of the formula (I) or the mixture of different 1,4-butanediol mono- and/or diesters of the formula (I) are well combinable with aroma chemicals which are different from compounds (I), allowing, in particular, the creation of aroma compositions (preferably fragrance compositions) having novel advantageous sensory profiles. Especially, as already explained above, the combinations can boost the sensory profile of aroma chemicals (such as for example of fragrances) wherein said aroma chemicals are different from compounds (I).

The compositions of the invention can comprise at least one aroma chemical that is different from compounds (I). Said at least one aroma chemical can for example be 1, 2, 3, 4, 5, 6, 7, 8 or more aroma chemicals, selected from the group consisting of:

Geranyl acetate (3,7-dimethyl-2,6 octadien-1yl acetate), alpha-hexylcinnamaldehyde, 2-phenoxyethyl isobutyrate (Phenirat¹), dihydromyrcenol (2,6-dimethyl-7-octen-2-ol), methyl dihydrojasmonate (preferably with a content of cis isomer of more than 60 wt. %) (Hedione⁹, Hedione HC⁹), 4,6,6,7,8,8-hexamethyl-1,3,4,6,7,8-hexahydrocyclopenta[g]benzopyran (Galaxolid³), tetrahydrolinalool (3,7-dimethyloctan-3-ol), ethyllinalool, benzyl salicylate, 2-methyl-3-(4-tert-butylphenyl)propanal (Lysmeral²), cinnamyl alcohol, 4,7-methano-3a,4,5,6,7,7a-hexahydro-5-indenyl acetate and/or 4,7-methano-3a,4,5,6,7,7a-hexahydro-6-indenyl acetate (Herbaflorat¹), citronellol, citronellyl acetate, tetrahydrogeraniol, vanillin, linalyl acetate, styrolyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthalene (Iso E Super³), hexyl salicylate, 4-tert-butylcyclohexyl acetate (Oryclone¹), 2-tert-butylcyclohexyl acetate (Agrumex HC¹), alpha-ionone (4-(2,2,6-trimethyl-2-cyclohexen-1-yl)-3-buten-2-one), n-alpha-methylionone, alpha-isomethylionone, coumarin, terpinyl acetate, 2-phenylethyl alcohol, 4-(4-hydroxy-4-methylpentyl)-3-cyclohexenecarboxaldehyde (Lyral³), alpha-amylcinnamaldehyde, ethylene brassylate, (E)- and/or (Z)-3-methylcyclopentadec-5-enone (Muscenon⁹), 15-pentadec-11-enolide and/or 15-pentadec-12-enolide (Globalide¹), 15-cyclopentadecanolide (Macrolide¹), 1-(5,6,7,8-tetrahydro-3,5,5,6,8,8-hexamethyl-2-naphthalenyl)ethanone (Tonalid¹⁰), 2-isobutyl-4-methyltetrahydro-2H-pyran-4-ol (Florol⁹), 2-ethyl-4-(2,2,3-trimethyl-3-cyclopenten-1-yl)-2-buten-1-ol (Sandolen¹), cis-3-hexenyl acetate, trans-3-hexenyl acetate, trans-2/cis-6-nonadienol, 2,4-dimethyl-3-cyclohexenecarboxaldehyde (Vertocitral¹), 2,4,4,7-tetramethyloct-6-en-3-one (Claritone¹), 2,6-dimethyl-5-hepten-1-al (Melonal²), borneol, 3-(3-isopropylphenyl)butanal (Florhydral²), 2-methyl-3-(3,4-methylenedioxyphenyl)-propanal (Helional³), 3-(4-ethylphenyl)-2,2-dimethylpropanal (Florazon¹), 7-methyl-2H-1,5-benzodioxepin-3(4H)-one (Calone), 3,3,5-trimethylcyclohexyl acetate (preferably with a content of cis isomers of 70 wt. %) or more, 2,5,5-trimethyl-1,2,3,4,4a,5,6,7-octahydronaphthalen-2-ol (Ambrinol S¹), 3-(4-tert-butylphenyl)-propanal (Bourgeonal⁴), ethyl 2-methylpentanoate (Manzanate⁴), ethoxymethoxycyclododecane (Amberwood¹), 2,4-dimethyl-4,4a,5,9b-tetrahydroindeno[1,2-d][1,3]dioxine (Magnolan¹), (2-tert-butylcyclohexyl) acetate (Verdox³) and 3-[5,5,6-trimethylbicyclo[2.2.1]hept-2-yl]cyclohexan-1-ol (Sandela⁴). Within the context of the present invention, the aforementioned aroma chemical(s) are accordingly preferably combined with a compound of formula (I), or a mixture of different compounds (I), as described above.

Where trade names are given above, these refer to the following sources:
¹ trade name of Symrise GmbH, Germany;
² trade name of BASF SE;
³ trade name of International Flavors & Fragrances Inc., USA;
⁴ Givaudan AG, Switzerland;
⁹ trade name of Firmenich S.A., Switzerland;
¹⁰ trade name of PFW Aroma Chemicals B.V., the Netherlands.

A preferred embodiment of the invention relates to a composition comprising a 1,4-butanediol mono- or diester of the formula (I) or a mixture of different 1,4-butanediol mono- and/or diesters of the formula (I) and at least one aroma chemical selected from the group consisting of methyl benzoate, benzyl acetate, geranyl acetate, 2-isobutyl-4-methyltetrahydro-2H-pyran-4-ol and linalool.

A further embodiment of the invention relates to a composition a 1,4-butanediol mono- or diester of the formula (I) or a mixture of different 1,4-butanediol mono- and/or diesters of the formula (I) and 2-isobutyl-4-methyltetrahydro-2H-pyran-4-ol.

A further embodiment of the invention relates to a composition comprising a 1,4-butanediol mono- or diester of the formula (I) or a mixture of different 1,4-butanediol mono- and/or diesters of the formula (I), and methyl benzoate.

A preferred embodiment of the invention relates to a composition comprising a 1,4-butanediol mono- or diester of the formula (I) or a mixture of different 1,4-butanediol mono- and/or diesters of the formula (I), and at least one further aroma chemical selected from the group consisting of ethylvanillin, vanillin, 2,5-dimethyl-4-hydroxy-2H-furan-3-one (furaneol) or 3-hydroxy-2-methyl-4H-pyran-4-one (maltol).

A preferred embodiment of the invention relates to a composition comprising a 1,4-butanediol mono- or diester of the formula (I) or a mixture of different 1,4-butanediol mono- and/or diesters of the formula (I), and at least one further aroma chemical selected from the group consisting of geranyl acetate, alpha-hexylcinnamaldehyde, 2-phenoxyethyl isobutyrate, dihydromyrcenol, methyl dihydrojasmonate (preferably with a content of cis isomer of more than 60 wt. %), 4,6,6,7,8,8-hexamethyl-1,3,4,6,7,8-hexahydrocyclopenta[g]benzopyran, tetrahydrolinalool, ethyllinalool, benzyl salicylate, 2-methyl-3-(4-tert-butylphenyl)propanal, cinnamyl alcohol, 4,7-methano-3a,4,5,6,7,7a-hexahydro-5-indenyl acetate, 4,7-methano-3a,4,5,6,7,7a-hexahydro-6-indenyl acetate, citronellyl acetate, tetrahydrogeraniol, linalyl acetate, styrolyl acetate, octahydro-2,3,8,8-tetramethyl-2-acetonaphthone, 2-acetyl-1,2,3,4,6,7,8-octahydro-2,3,8,8-tetramethylnaphthalene, hexyl salicylate, 4-tert-butylcyclohexyl acetate, 2-tert-butylcyclohexyl acetate, alpha-ionone, n-alpha-methylionone, alpha-isomethylionone, coumarin, terpinyl acetate, 4-(4-hydroxy-4-methylpentyl)-3-cyclohexenecarboxaldehyde, alpha-amylcinnamaldehyde, ethylene brassylate, (E)-3-methylcyclopentadec-5-enone, (Z)-3-methylcyclopentadec-5-enone, 15-pentadec-11-enolide, 15-pentadec-12-enolide, 15-cyclopentadecanolide, 1-(5,6,7,8-tetrahydro-3,5,5,6,8,8-hexamethyl-2-naphthalenyl)ethanone, 2-isobutyl-4-methyltetrahydro-2H-pyran-4-ol, 2-ethyl-4-(2,2,3-trimethyl-3-cyclopenten-1-yl)-2-buten-1-ol, cis-3-hexenyl acetate, trans-3-hexenyl acetate, trans-2/cis-6-nonadienol, 2,4-dimethyl-3-cyclohexenecarboxaldehyde, 2,4,4,7-tetramethyloct-6-en-3-one, 2,6-dimethyl-5-hepten-1-al, borneol, 3-(3-isopropylphenyl)butanal, 2-methyl-3-(3,4-methylenedioxyphenyl)propanal, 3-(4-ethylphenyl)-2,2-dimethylpropanal, 7-methyl-2H-1,5-benzodioxepin-3(4H)-one, 3,3,5-trimethylcyclohexyl acetate (preferably with a content of cis isomers of 70 wt. % or more), 2,5,5-trimethyl-1,2,3,4,4a,5,6,7-octahydronaphthalen-2-ol, 3-(4-tert-butylphenyl)-propanal, ethyl 2-methylpentanoate, ethoxymethoxycyclododecane, 2,4-dimethyl-4,4a,5,9b-tetrahydroindeno[1,2-d][1,3]dioxine, (2-tert-butylcyclohexyl) acetate, 3-[5,5,6-trimethylbicyclo[2.2.1]hept-2-yl]cyclohexan-1-ol,

menthone, isomenthone, carvone, beta-n-methylionone, beta-isomethylionone, alpha-irone, alpha-damascone, beta-damascone, delta-damascone, acetylated cedar wood oil, and mixtures thereof.

Further aroma chemicals with which the 1,4-butanediol mono- or diester of the formula (I) or the mixture of different 1,4-butanediol mono- and/or diesters of the formula (I) can be combined to give a composition according to the invention can be found, e.g., in S. Arctander, Perfume and Flavor Chemicals, Vol. I and II, Montclair, N. J., 1969, self-published or K. Bauer, D. Garbe and H. Surburg, Common Fragrance and Flavor Materials, 4th Ed., Wiley-VCH, Weinheim 2001. Specifically, mention may be made of:
extracts from natural raw materials such as essential oils, concretes, absolutes, resins, resinoids, balsams, tinctures such as e.g.
ambergris tincture; amyris oil; angelica seed oil; angelica root oil; aniseed oil; valerian oil; basil oil; tree moss absolute; bay oil; mugwort oil; benzoin resin; bergamot oil; beeswax absolute; birch tar oil; bitter almond oil; savory oil; buchu leaf oil; cabreuva oil; cade oil; calmus oil; camphor oil; cananga oil; cardamom oil; cascarilla oil; cassia oil; cassia absolute; castoreum absolute; cedar leaf oil; cedar wood oil; cistus oil; citronella oil; lemon oil; copaiba balsam; copaiba balsam oil; coriander oil; costus root oil; cumin oil; cypress oil; davana oil; dill weed oil; dill seed oil; Eau de brouts absolute; oak moss absolute; elemi oil; tarragon oil; eucalyptus citriodora oil; eucalyptus oil; fennel oil; pine needle oil; galbanum oil; galbanum resin; geranium oil; grapefruit oil; guaiacwood oil; gurjun balsam; gurjun balsam oil; helichrysum absolute; helichrysum oil; ginger oil; iris root absolute; iris root oil; jasmine absolute; calmus oil; camomile oil blue; roman camomile oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemongrass oil; lovage oil; lime oil distilled; lime oil pressed; linalool oil; litsea cubeba oil; laurel leaf oil; mace oil; marjoram oil; mandarin oil; massoia bark oil; mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange blossom absolute; orange oil; origanum oil; palmarosa oil; patchouli oil; perilla oil; peru balsam oil; parsley leaf oil; parsley seed oil; petitgrain oil; peppermint oil; pepper oil; pimento oil; pine oil; pennyroyal oil; rose absolute; rose wood oil; rose oil; rosemary oil; Dalmatian sage oil; Spanish sage oil; sandalwood oil; celery seed oil; spike-lavender oil; star anise oil; styrax oil; tagetes oil; fir needle oil; tea tree oil; turpentine oil; thyme oil; tolubalsam; tonka absolute; tuberose absolute; vanilla extract; violet leaf absolute; verbena oil; vetiver oil; juniper berry oil; wine lees oil; wormwood oil; winter green oil; hyssop oil; civet absolute; cinnamon leaf oil; cinnamon bark oil, and fractions thereof, or ingredients isolated therefrom;
individual fragrances from the group of hydrocarbons, such as e.g. 3-carene; alpha-pinene; beta-pinene; alpha-terpinene; gamma-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;
the aliphatic alcohols such as e.g. hexanol; octanol; 3-octanol; 2,6-dimethylheptanol; 2-methyl-2-heptanol; 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;
the aliphatic aldehydes and acetals thereof such as e.g. hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethylacetal; 1,1-dimethoxy-2,2,5-trimethyl-4-hexene; citronellyloxyacetaldehyde; (E/Z)-1-(1-methoxypropoxy)-hex-3-ene; the aliphatic ketones and oximes thereof such as e.g. 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;
the aliphatic sulfur-containing compounds such as e.g. 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;
the aliphatic nitriles such as e.g. 2-nonenenitrile; 2-undecenenitrile; 2-tridecenenitrile; 3,12-tridecadienenitrile; 3,7-dimethyl-2,6-octadienenitrile; 3,7-dimethyl-6-octenenitrile;
the esters of aliphatic carboxylic acids such as e.g. (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl iso-valerate; ethyl 2-methylpentanoate; ethyl hexanoate; allyl hexanoate; ethyl heptanoate; allyl heptanoate; ethyl octanoate; ethyl (E,Z)-2,4-decadienoate; methyl 2-octinate; methyl 2-noninate; allyl 2-isoamyloxy acetate; methyl-3,7-dimethyl-2,6-octadienoate; 4-methyl-2-pentyl crotonate;
the acyclic terpene alcohols such as e.g. geraniol; nerol; linalool; lavandulol; nerolidol; farnesol; tetrahydrolinalool; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates and 3-methyl-2-butenoates thereof;
the acyclic terpene aldehydes and ketones such as e.g. geranial; neral; citronellal; 7-hydroxy-3,7-dimethyloctanal; 7-methoxy-3,7-dimethyloctanal; 2,6, 10-trimethyl-9-undecenal; geranyl acetone; as well as the dimethyl- and diethylacetals of geranial, neral, 7-hydroxy-3,7-dimethyloctanal; the cyclic terpene alcohols such as e.g. menthol; isopulegol; alpha-terpineol; terpine-4-ol; menthan-8-ol; menthan-1-ol; menthan-7-ol; borneol; isoborneol; linalool oxide; nopol; cedrol; ambrinol; vetiverol; guajol; and the formates, acetates, propionates, isobutyrates, butyrates, isovalerates, pentanoates, hexanoates, crotonates, tiglinates and 3-methyl-2-butenoates thereof;
the cyclic terpene aldehydes and ketones such as e.g. menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methano-naphthalene-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedar wood oil (methyl cedryl ketone);
the cyclic alcohols such as e.g. 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;
the cycloaliphatic alcohols such as e.g. alpha-3,3-trimethylcyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;
the cyclic and cycloaliphatic ethers such as e.g. cineol; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo-[10.1.0]trideca-4,8-diene; rose oxide; 2-(2,4-dimethyl-3-cyclohexen-1-yl)-5-methyl-5-(1-methylpropyl)-1,3-dioxane;
the cyclic and macrocyclic ketones such as e.g. 4-tert-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 7-cyclohexadecen-1-one; (7/8)-cyclohexadecen-1-one; 9-cycloheptadecen-1-one; cyclopentadecanone; cyclohexadecanone;
the cycloaliphatic aldehydes such as e.g. 2,4-dimethyl-3-cyclohexenecarbaldehyde; 2-methyl-4-(2,2,6-trimethylcyclohexen-1-yl)-2-butenal; 4-(4-hydroxy-4-methylpentyl)-3-cyclohexene carbaldehyde; 4-(4-methyl-3-penten-1-yl)-3-cyclohexenecarbaldehyde;
the cycloaliphatic ketones such as e.g. 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert-butyl (2,4-dimethyl-3-cyclohexen-1-yl) ketone;
the esters of cyclic alcohols such as e.g. 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate;
4,7-methano-3a,4,5,6,7,7a-hexahydro-5 or 6-indenyl isobutyrate; 4,7-methanooctahydro-5 or 6-indenyl acetate;
the esters of cycloaliphatic alcohols such as e.g. 1-cyclohexylethyl crotonate;
the esters of cycloaliphatic carboxylic acids such as e.g. allyl 3-cyclohexylpropionate; allyl cyclohexyloxyacetate; cis- and trans-methyl dihydrojasmonate; cis- and trans-methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexene-carboxylate; ethyl 2-methyl-1,3-dioxolane-2-acetate;
the araliphatic alcohols such as e.g. benzyl alcohol; 1-phenylethyl alcohol, 2-phenylethyl alcohol, 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;
the esters of araliphatic alcohols and aliphatic carboxylic acids such as e.g. benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha, alpha-dimethylphenylethyl acetate; alpha,alpha-dimethylphenylethyl butyrate; cinnamyl acetate; 2-phenoxyethyl isobutyrate; 4-methoxybenzyl acetate;
the araliphatic ethers such as e.g. 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxine; 4,4a,5,9b-tetrahydro-2,4-dimethylindeno[1,2-d]-m-dioxine;
the aromatic and araliphatic aldehydes such as e.g. benzaldehyde; phenylacetaldehyde; 3-phenylpropanal; hydratropaaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 2-methyl-3-(4-isobutylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;
the aromatic and araliphatic ketones such as e.g. acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)-ethanone; 2-benzofuranylethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;
the aromatic and araliphatic carboxylic acids and esters thereof such as e.g. benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;
the nitrogen-containing aromatic compounds such as e.g. 2,4,6-trinitro-1,3-dimethyl-5-tert-butylbenzene; 3,5-dinitro-2,6-dimethyl-4-tert-butylacetophenone; cinnamonitrile; 3-methyl-5-phenyl-2-pentenonitrile; 3-methyl-5-phenylpentanonitrile; methyl anthranilate; methyl-N-methylanthranilate; Schiff bases of methyl anthranilate with 7-hydroxy-3,7-dimethyloctanal, 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropyl-pyrazine; 2-isobutyl-3-methoxypyrazine;
the phenols, phenyl ethers and phenyl esters such as e.g. estragole; anethole; eugenol; eugenyl methyl ether; isoeugenol; isoeugenyl methyl ether; thymol; carvacrol; di-phenyl ether; beta-naphthyl methyl ether; beta-naphthyl ethyl ether; beta-naphthyl iso-butyl ether; 1,4-dimethoxybenzene; eugenyl acetate; 2-methoxy-4-methylphenol; 2-ethoxy-5-(1-propenyl)phenol; p-cresyl phenylacetate;
the heterocyclic compounds such as e.g. 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
the lactones such as e.g. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin; octahydrocoumarin.

### Non-Aroma Chemical Carriers

A further embodiment of the invention is directed to a composition comprising a 1,4-butanediol mono- or diester of the formula (I) or a mixture of different 1,4-butanediol mono- and/or diesters of the formula (I), and at least one non-aroma chemical carrier.

The at least one non-aroma chemical carrier can be a compound, a mixture of compounds or other additives, which has/have no or no noteworthy sensory properties. The non-aroma chemical carrier can serve for the dilution and/or the fixing of the compound (I) and optionally the at least one aroma chemical, as defined above, or any other component, if comprised in the composition.

A further embodiment of the invention is directed to a composition comprising a 1,4-butanediol mono- or diester of the formula (I) or a mixture of different 1,4-butanediol mono- and/or diesters of the formula (I), and at least one non-aroma chemical carrier selected from the group consisting of solvents, surfactants and oil components.

According to preferred embodiments of the present invention, said non-aroma chemical carrier(s) is/are selected from the solvents, surfactants and oil components listed below.

One embodiment of the invention is directed to a composition comprising a 1,4-butanediol mono- or diester of the formula (I) or a mixture of different 1,4-butanediol mono- and/or diesters of the formula (I), as described herein and at least one solvent.

In the context of the present invention, a “solvent” serves for the dilution of the compound(s) (1) to be used according to the invention and/or any further component of the composition without having its own aroma.

The one or more solvent(s) can be present in the composition in amount of 0.01 to 99 wt. % based on the composition. In a preferred embodiment of the invention, the composition comprises 0.1 to 90 wt. %, preferably 0.5 to 80 wt. % of solvent(s) based on the total weight of the composition. The amount of solvent(s) can be chosen depending on the composition. In one embodiment of the invention, the composition comprises 0.05 to 10 wt. %, preferably 0.1 to 5 wt. %, more preferably 0.2 to 3 wt. % based on the total weight of the composition. In one embodiment of the invention, the composition comprises 20 to 70 wt. %, preferably 25 to 50 wt. % of solvent(s) based on the total weight of the composition.

Preferred solvents are ethanol, isopropanol, dipropylene glycol (DPG), propylene glycol, 1,2-butylene glycol, glycerol, diethylene glycol monoethyl ether, diethyl phthalate (DEP), isopropyl myristate (IPM), triethyl citrate (TEC), and benzyl benzoate (BB).

Especially preferred solvents are selected from the group consisting of ethanol, propylene glycol, dipropylene glycol, triethyl citrate, benzyl benzoate and isopropyl myristate.

In a preferred embodiment of the invention, the solvent is selected from the group consisting of ethanol, isopropanol, diethylene glycol monoethyl ether, glycerol, propylene glycol, 1,2-butylene glycol, dipropylene glycol, triethyl citrate and isopropyl myristate.

In a particular embodiment of the invention, the solvent is selected from the group consisting of isopropanol, dipropylene glycol (DPG), propylene glycol, 1,2-butylene glycol, diethylene glycol monoethyl ether, diethyl phthalate (DEP), isopropyl myristate (IPM), triethyl citrate (TEC), benzyl benzoate and mixtures thereof. More particularly, the solvent is selected from the group consisting of isopropanol, isopropyl myristate (IPM), triethyl citrate (TEC), benzyl benzoate and mixtures thereof.

According to a further embodiment, the 1,4-butanediol mono- or diester of the formula (I) or the mixture of different 1,4-butanediol mono- and/or diesters of the formula (I), is used according to the present invention in surfactant-containing compositions. Due to its characteristic fragrance property and its substantivity, tenacity as well as stability, the 1,4-butanediol mono- or diester of the formula (I) or the mixture of different 1,4-butanediol mono- and/or diesters of the formula (I) can especially be used to provide an odor, preferably a fragrance impression to surfactant-containing compositions such as, for example, cleaners (in particular laundry care products and all-purpose cleaners). It can preferably be used to impart a long-lasting clean note to a surfactant comprising composition.

One embodiment of the invention is therefore directed to a composition comprising a 1,4-butanediol mono- or diester of the formula (I) or a mixture of different 1,4-butanediol mono- and/or diesters of the formula (I), and at least one surfactant.

The surfactant(s) may be selected from anionic, non-ionic, cationic and/or amphoteric or zwitterionic surfactants. Surfactant-containing compositions, such as for example shower gels, foam baths, shampoos, etc., preferably contain at least one anionic surfactant.

The compositions according to the invention usually contain the surfactant(s), in the aggregate, in an amount of 0 to 40 wt. %, preferably 0 to 20 wt. %, more preferably 0.1 to 15 wt. %, and particularly 0.1 to 10 wt. %, based on the total weight of the composition. Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, optionally partly oxidized alk(en)yl oligoglycosides or glucuronic acid derivatives, fatty acid-N-alkyl glucamides, protein hydrolyzates (particularly wheat-based vegetable products), polyol fatty acid esters, sugar esters, sorbitan esters, polysorbates and amine oxides. If the nonionic surfactants contain polyglycol ether chains, they may have a conventional homolog distribution, although they preferably have a narrow-range homolog distribution.

Zwitterionic surfactants are surface-active compounds which contain at least one quaternary ammonium group and at least one —COO⁽⁻⁾ or —SO₃⁽⁻⁾ group in the molecule. Particularly suitable zwitterionic surfactants are the so-called betaines, such as the N-alkyl-N,N-dimethyl ammonium glycinates, for example, cocoalkyl dimethyl ammonium glycinate, N-acylaminopropyl-N,N-dimethyl ammonium glycinates, for example, co-coacylaminopropyl dimethyl ammonium glycinate, and 2-alkyl-3-carboxymethyl-3-hydroxyethyl imidazolines, containing 8 to 18 carbon atoms in the alkyl or acyl group, and cocoacylaminoethyl hydroxyethyl carboxymethyl glycinate. The fatty acid amide derivative known under the CTFA name of Cocamidopropyl Betaine is particularly preferred.

Ampholytic surfactants are also suitable, particularly as co-surfactants. Ampholytic surfactants are surface-active compounds which, in addition to a C₈ to C₁₈ alkyl or acyl group, contain at least one free amino group and at least one —COOH— or —SO₃H— group in the molecule and which are capable of forming inner salts. Examples of suitable ampholytic surfactants are N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids and alkylaminoacetic acids containing around 8 to 18 carbon atoms in the alkyl group. Particularly preferred ampholytic surfactants are N-cocoalkylaminopropionate, cocoacylaminoethyl aminopropionate and acyl sarcosine.

Anionic surfactants are characterized by a water-solubilizing anionic group such as, for example, a carboxylate, sulfate, sulfonate or phosphate group and a lipophilic group. Dermatologically safe anionic surfactants are known to the practitioner in large numbers from relevant textbooks and are commercially available. They are, in particular, alkyl sulfates in the form of their alkali metal, ammonium or alkanolammonium salts, alkylether sulfates, alkylether carboxylates, acyl isethionates, acyl sarcosinates, acyl taurines containing linear C₁₂-C₁₈ alkyl or acyl groups and sulfosuccinates and acyl glutamates in the form of their alkali metal or ammonium salts.

Particularly suitable cationic surfactants are quaternary ammonium compounds, preferably ammonium halides, more especially chlorides and bromides, such as alkyl trimethyl ammonium chlorides, dialkyl dimethyl ammonium chlorides and trialkyl methyl ammonium chlorides, for example, cetyl trimethyl ammonium chloride, stearyl trim ethyl ammonium chloride, distearyl dimethyl ammonium chloride, lauryl dimethyl ammonium chloride, lauryl dimethyl benzyl ammonium chloride and tricetyl methyl ammonium chloride. In addition, the readily biodegradable quaternary ester compounds, such as, for example, the dialkyl ammonium methosulfates and methyl hydroxyalkyl dialkoyloxyalkyl ammonium methosulfates marketed under the name of Stepantexe and the corresponding products of the Dehyquart® series, may be used as cationic surfactants. “Esterquats” are generally understood to be quaternized fatty acid triethanolamine ester salts. They can provide the compositions with particular softness. They are known substances which are prepared by the relevant methods of organic chemistry. Other cationic surfactants suitable for use in accordance with the invention are the quaternized protein hydrolyzates.

One embodiment of the invention is directed to a composition a 1,4-butanediol mono- or diester of the formula (I) or a mixture of different 1,4-butanediol mono- and/or diesters of the formula (I), and at least one oil component.

The oil components are typically present in an amount of 0.1 to 80 wt. %, preferably 0.5 to 70 wt. %, more preferably 1 to 60 wt. %, even more preferably 1 to 50 wt. %, in particular 1 to 40 wt. %, more particularly 5 to 25 wt. % and specifically 5 to 15 wt. % based on the total weight of the composition.

The oil components may be selected, for example, from Guerbet alcohols based on fatty alcohols containing 6 to 18, preferably 8 to 10, carbon atoms and other additional esters, such as myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of C₁₈-C₃₈ alkyl-hydroxycarboxylic acids with linear or branched C₆-C₂₂ fatty alcohols, more especially dioctyl malate, esters of linear and/or branched fatty acids with polyhydric alcohols (for example propylene glycol, dimer dial or trimer triol), triglycerides based on C₆-C₁₀ fatty acids, liquid mono-, di- and triglyceride mixtures based on C₆-C₁₈ fatty acids, esters of C₆-C₂₂ fatty alcohols and/or Guerbet alcohols with aromatic carboxylic acids, more particularly benzoic acid, esters of dicarboxylic acids with polyols containing 2 to 10 car-bon atoms and 2 to 6 hydroxyl groups, vegetable oils, branched primary alcohols, substituted cyclohexanes, linear and branched C₆-C₂₂ fatty alcohol carbonates such as, for example, dicaprylyl carbonate (Cetiol® CC), Guerbet carbonates based on fatty alcohols containing 6 to 18, preferably 8 to 10, carbon atoms, esters of benzoic acid with linear and/or branched C₆ to C₂₂ alcohols (for example Finsolv® TN), linear or branched, symmetrical or nonsymmetrical dialkyl ethers containing 6 to 22 carbon atoms per alkyl group such as, for example, dicaprylyl ether (Cetiol® OE), ring opening products of epoxidized fatty acid esters with polyols and hydrocarbons or mixtures thereof.

### Anti-Oxidants

One embodiment of the invention is directed to a composition comprising a 1,4-butanediol mono- or diester of the formula (I) or a mixture of different 1,4-butanediol mono- and/or diesters of the formula (I), and at least one anti-oxidant.

Anti-oxidants are able to inhibit or prevent the undesired changes in the compositions to be protected caused by oxygen effects and other oxidative processes. The effect of the anti-oxidants consists in most cases in them acting as free-radical scavengers for the free radicals which arise during autoxidation.

Anti-oxidants can for example be selected from the group consisting of
amino acids (for example glycine, alanine, arginine, serine, threonine, histidine, tyrosine, tryptophan) and derivatives thereof,
imidazoles (e.g. urocanic acid) and derivatives thereof,
peptides, such as D,L-carnosine, D-carnosine, L-carnosine (=-β-Alanyl-L-histidin) and derivatives thereof
carotenoids, carotenes (e.g. alpha-carotene, beta-carotene, lycopene, lutein) or derivatives thereof,
chlorogenic acid and derivatives thereof,
lipoic acid and derivatives thereof (for example dihydrolipoic acid),
auro-thioglucose, propylthiouracil and other thiols (for example thioredoxin, glutathione, cysteine, cystine, cystamine and the glycosyl, N-acetyl, methyl, ethyl, propyl, amyl, butyl and lauryl, palmitoyl, oleyl, gamma-linoleyl, cholesteryl and glyceryl esters thereof) and salts thereof,
dilauryl thiodipropionate, distearyl thiodipropionate, thiodipropionic acid and derivatives thereof (esters, ethers, peptides, lipids, nucleotides, nucleosides and salts),
sulfoximine compounds (for example buthionine sulfoximines, homocysteine sulfoximine, buthionine sulfones, penta-, hexa-, heptathionine sulfoximine)
(metal) chelating agents (e.g. alpha-hydroxy fatty acids, palmitic acid, phytic acid, lactoferrin),
alpha-hydroxy acids (for example citric acid, lactic acid, malic acid),
humic acid, bile acid, bile extracts, bilirubin, biliverdin, boldin (=alkaloid from the plant Peumus boldus, boldo extract,
EDTA, EGTA and derivatives thereof,
unsaturated fatty acids and derivatives thereof (e.g. gamma-linolenic acid, linoleic acid, oleic acid),
folic acid and derivatives thereof,
ubiquinone and ubiquinol and derivatives thereof,
vitamin C and derivatives (for example ascorbyl palmitate, Mg ascorbyl phosphate, ascorbyl acetate),
tocopherols and derivatives (for example vitamin E acetate),
vitamin A and derivatives (for example vitamin A palmitate),
coniferyl benzoate of gum benzoin, rutic acid and derivatives thereof, alpha-glycosylrutin, ferulic acid, furfurylideneglucitol,
butylhydroxytoluene (BHT), butylhydroxyanisole (BHA)
nordihydroguaiacic acid, nordihydroguaiaretic acid, trihydroxybutyrophenone, uric acid and derivatives thereof, mannose and derivatives thereof,
superoxide dismutase
zinc and derivatives thereof (for example ZnO, ZnSO4),
selenium and derivatives thereof (for example selenomethionine) and
stilbenes and derivatives thereof (e.g. stilbene oxide, trans-stilbene oxide)

In a preferred embodiment, the anti-oxidant is selected from the group consisting of pentaerythrityl, tetra-di-t-butyl hydroxyhydrocinnamate, nordihydroguaiaretic acid, ferulic acid, resveratrol, propyl gallate, butylhydroxytoluene (BHT), butylhydroxyanisole (BHA), ascorbyl palmitate and tocopherol.

The compositions according to the invention can comprise the anti-oxidants in an amount of 0.001 to 25 wt.-%, preferably 0.005 to 10 wt.-%, preferably 0.01 to 8 wt.-%, preferably 0.025 to 7 wt.-%, preferably 0.05 to 5 wt.-%, based on the total weight of the composition.

### Deodorant-Active Agents

One embodiment of the invention is directed to a composition comprising a 1,4-butanediol mono- or diester of the formula (I) or a mixture of different 1,4-butanediol mono- and/or diesters of the formula (I), and at least one deodorant-active agent.

The 1,4-butanediol mono- or diester of the formula (I) or the mixture of different 1,4-butanediol mono- and/or diesters of the formula (I) can be used to impart a clean, long-lasting note to deodorizing compositions as well as to the skin treated with such compositions.

Deodorizing compositions (deodorants and antiperspirants) counteract, mask or eliminate body odors. Body odors are formed through the action of skin bacteria on apocrine perspiration which results in the formation of unpleasant-smelling degradation products.

In a preferred embodiment of the invention, the at least one deodorant-active agent is selected from the groups consisting of anti-perspirants, esterase inhibitors and antibacterial agents.

Suitable antiperspirants can be selected from the group consisting of salts of aluminium, zirconium or zinc. Examples are aluminium chloride, aluminium chlorohydrate, aluminium dichlorohydrate, aluminium sesquichlorohydrate and complex compounds thereof, for example with 1,2-propylene glycol, aluminium hydroxyallantoinate, aluminium chloride tartrate, aluminium zirconium trichlorohydrate, aluminium zirconium tetra-chlorohydrate, aluminium zirconium pentachlorohydrate and complex compounds thereof, for example with amino acids, such as glycine. Aluminium chlorohydrate, aluminium zirconium tetrachlorohydrate, aluminium zirconium pentachlorohydrate and complex compounds thereof are preferably used.

In a preferred embodiment of the invention the compositions comprise at least one antiperspirant selected from the group consisting aluminium chloride, aluminium chlorohydrate, aluminium dichlorohydrate, aluminium sesquichlorohydrate, aluminium hydroxyallantoinate, aluminium chloride tartrate, aluminium zirconium trichlorohydrate, aluminium zirconium tetrachlorohydrate and aluminium zirconium pentachlorohydrate

The compositions according to the invention can comprise the antiperspirants in an amount of 1 to 50, preferably 5 to 30 and more particularly 10 to 25 wt.-%, based on the solids content of the composition.

Where perspiration is present in the underarm region, extracellular enzymes-esterases, mainly proteases and/or lipases are formed by bacteria and split the esters present in the perspiration, releasing odors in the process. Suitable esterase inhibitors are for example trialkyl citrates, such as trimethyl citrate, tripropyl citrate, triisopropyl citrate, tributyl citrate and, in particular, triethyl citrate. Esterase inhibitors inhibit enzyme activity and thus reduce odor formation. The free acid is probably released by the cleavage of the citric acid ester and reduces the pH value of the skin to such an extent that the enzymes are inactivated by acylation. Other esterase inhibitors are sterol sulfates or phosphates such as, for example, lanosterol, cholesterol, campesterol, stigmasterol and sitosterol sulfate or phosphate, dicarboxylic acids and esters thereof, for example glutaric acid, glutaric acid monoethyl ester, glutaric acid diethyl ester, adipic acid, adipic acid monoethyl ester, adipic acid diethyl ester, malonic acid and malonic acid diethyl ester, hydroxycarboxylic acids and esters thereof, for example citric acid, malic acid, tartaric acid or tartaric acid diethyl ester, and zinc glycinate.

In a preferred embodiment of the invention the compositions comprise at least one esterase inhibitor selected from the group consisting of trimethyl citrate, tripropyl citrate, triisopropyl citrate, tributyl citrate triethyl citrate, lanosterol, cholesterol, campesterol, stigmasterol, sitosterol sulfate, sitosterol phosphate, glutaric acid, glutaric acid monoethyl ester, glutaric acid diethyl ester, adipic acid, adipic acid monoethyl ester, adipic acid diethyl ester, malonic acid, malonic acid diethyl ester, citric acid, malic acid, tartaric acid, tartaric acid diethyl ester and zinc glycinate.

The compositions according to the invention can comprise the esterase inhibitors in amounts of 0.01 to 20, preferably 0.1 to 10 and more particularly 0.5 to 5 wt.-%, based on the solids content of the composition.

The term “anti-bacterial agents” as used herein encompasses substances which have bactericidal and/or bacteriostatic properties. Typically these substances act against gram-positive bacteria such as, for example, 4-hydroxybenzoic acid and salts and esters thereof, N-(4-chlorophenyl)-N′-(3,4-dichlorophenyl)-urea, 2,4,4′-trichloro-2′-hydroxydiphenylether (triclosan), 4-chloro-3,5-dimethylphenol, 2,2′-methylene-bis-(6-bromo-4-chlorophenol), 3-methyl-4-(1-methylethyl)-phenol, 2-benzyl-4-chlorophenol, 3-(4-chlorophenoxy)-propane-1,2-diol, 3-iodo-2-propinyl butyl carbamate, chlorhexidine, 3,4,4′-trichlorocarbanilide (TTC), phenoxyethanol, glycerol monocaprate, glycerol monocaprylate, glycerol monolaurate (GML), diglycerol monocaprate (DMC), salicylic acid-N-alkylamides such as, for example, salicylic acid-n-octyl amide or salicylic acid-n-decyl amide.

In a preferred embodiment the antibacterial agent is selected from the group consisting of chitosan, phenoxyethanol, 5-chloro-2-(2,4-dichlorophenoxy)-phenol, 4-hydroxybenzoic acid and salts and esters thereof, N-(4-chlorophenyl)-N′-(3,4-dichlorophenyl)-urea, 2,4,4′-trichloro-2′-hydroxydiphenylether (triclosan), 4-chloro-3,5-dimethylphenol, 2,2′-methylene-bis-(6-bromo-4-chlorophenol), 3-methyl-4-(1-methylethyl)-phenol, 2-benzyl-4-chlorophenol, 3-(4-chlorophenoxy)-propane-1,2-diol, 3-iodo-2-propinyl butyl carbamate, chlorhexidine, 3,4,4′-trichlorocarbanilide (TTC), phenoxyethanol, glycerol monocaprate, glycerol monocaprylate, glycerol monolaurate (GML), diglycerol monocaprate (DMC), salicylic acid-N-alkylamides.

The compositions according to the invention can comprise the antibacterial agents in amounts of 0.01 to 5 wt. % and preferably 0.1 to 2 wt.-%, based on the solids content of the composition.

The compositions according to the invention can further comprise one or more substances, such as, for example: preservatives, abrasives, anti-acne agents, agents to combat skin aging, anti-cellulite agents, antidandruff agents, anti-inflammatory agents, irritation-preventing agents, irritation-alleviating agents, astringents, sweat-inhibiting agents, antiseptics, anti-statics, binders, buffers, carrier materials, chelating agents, cell stimulants, care agents, hair removal agents, emulsifiers, enzymes, essential oils, fibers, film formers, fixatives, foam formers, foam stabilizers, substances for preventing foaming, foam boosters, fungicides, gelling agents, gel-forming agents, hair care agents, hair shaping agents, hair smoothing agents, moisture-donating agents, moisturizing substances, humectant substances, bleaching agents, strengthening agents, stain removal agents, optical brighteners, impregnating agents, soil repellents, friction-reducing agents, lubricants, moisturizing creams, ointments, opacifiers, plasticizers, covering agents, polish, shine agents, polymers, powders, proteins, refatting agents, exfoliating agents, silicones, skin-calming agents, skin-cleansing agents, skin care agents, skin-healing agents, skin lightening agents, skin-protective agents, skin-softening agents, cooling agents, skin-cooling agents, warming agents, skin-warming agents, stabilizers, UV-absorbent agents, UV filters, fabric softeners, suspending agents, skin-tanning agents, thickeners, vitamins, waxes, fats, phospholipids, saturated fatty acids, mono- or polyunsaturated fatty acids, α-hydroxy acids, polyhydroxy fatty acids, liquefiers, dyes, color-protection agents, pigments, anti-corrosives, polyols, electrolytes, or silicone derivatives.

The 1,4-butanediol mono- or diester of the formula (I) or the mixture of different 1,4-butanediol mono- and/or diesters of the formula (I), as described herein can be used in a wide range of compositions, preferably in aroma compositions, more preferably in fragrance compositions. The olfactory properties and the substance properties (such as solubility in customary solvents and compatibility with further customary constituents of such compositions) of the compounds (I) underline the particular suitability of the combinations for the stated use purposes and compositions.

Suitable compositions are for example perfume compositions, body care compositions (including cosmetic compositions), products for oral and dental hygiene, hygiene articles, cleaning compositions (including dishwashing compositions), textile detergent compositions, compositions for scent dispensers, foods, food supplements, pharmaceutical compositions and crop protection compositions.

Perfume compositions can be selected from fine fragrances, air fresheners in liquid form, gel-like form or a form applied to a solid carrier, aerosol sprays, scented cleaners, perfume candles and oils, such as lamp oils or oils for massage.

Examples for fine fragrances are perfume extracts, Eau de Parfums, Eau de Toilettes, Eau de Colognes, Eau de Solide and Extrait Parfum.

Body care compositions include cosmetic compositions, and can be selected from after-shaves, pre-shave products, splash colognes, solid and liquid soaps, shower gels, shampoos, shaving soaps, shaving foams, bath oils, cosmetic emulsions of the oil-in-water type, of the water-in-oil type and of the water-in-oil-in-water type, such as e.g. skin creams and lotions, face creams and lotions, sunscreen creams and lotions, after-sun creams and lotions, hand creams and lotions, foot creams and lotions, hair removal creams and lotions, after-shave creams and lotions, tanning creams and lotions, hair care products such as e.g. hairsprays, hair gels, setting hair lotions, hair conditioners, hair shampoo, permanent and semi-permanent hair colorants, hair shaping compositions such as cold waves and hair smoothing compositions, hair tonics, hair creams and hair lotions, deodorants and antiperspirants such as e.g. underarm sprays, roll-ons, deodorant sticks and deodorant creams, products of decorative cosmetics such as e.g. eye-liners, eye-shadows, nail varnishes, make-ups, lipsticks and mascara. Further examples are given above.

Products for oral and dental hygiene can be selected from toothpaste, dental floss, mouth wash, breath fresheners, dental foam, dental gels and dental strips.

Hygiene articles can be selected from joss sticks, insecticides, repellents, propellants, rust removers, perfumed freshening wipes, armpit pads, baby diapers, sanitary towels, toilet paper, cosmetic wipes, pocket tissues, dishwasher and deodorizer.

Cleaning compositions, such as e.g. cleaners for solid surfaces, can be selected from perfumed acidic, alkaline and neutral cleaners, such as e.g. floor cleaners, window cleaners, dishwashing compositions both for handwashing and machine washing use, bath and sanitary cleaners, scouring milk, solid and liquid toilet cleaners, powder and foam carpet cleaners, waxes and polishes such as furniture polishes, floor waxes, shoe creams, disinfectants, surface disinfectants and sanitary cleaners, brake cleaners, pipe cleaners, limescale removers, grill and oven cleaners, algae and moss removers, mold removers, facade cleaners.

Textile detergent compositions can be selected from liquid detergents, powder detergents, laundry pretreatments such as bleaches, soaking agents and stain removers, fabric softeners, washing soaps, washing tablets.

Food means a raw, cooked, or processed edible substance, ice, beverage or ingredient used or intended for use in whole or in part for human consumption, or chewing gum, gummies, jellies, and confectionaries.

A food supplement is a product intended for ingestion that contains a dietary ingredient intended to add further nutritional value to the diet. A dietary ingredient may be one, or any combination, of the following substances: a vitamin, a mineral, an herb or other botanical, an amino acid, a dietary substance for use by people to supplement the diet by increasing the total dietary intake, a concentrate, metabolite, constituent, or extract.

Food supplements may be found in many forms such as tablets, capsules, softgels, gelcaps, liquids, or powders.

Pharmaceutical compositions comprise compositions which are intended for use in the diagnosis, cure, mitigation, treatment, or prevention of disease as well as articles (other than food) intended to affect the structure or any function of the body of man or other animals.

Crop protection compositions comprise compositions which are intended for the managing of plant diseases, weeds and other pests (both vertebrate and invertebrate) that damage agricultural crops and forestry. A more detailed definition is given above.

Preferably, the composition of the invention is a perfume composition, a body care composition (including cosmetic compositions), a product for oral and dental hygiene, a hygiene article, a cleaning composition (including dishwashing compositions), a textile detergent composition, a composition for scent dispensers, or a crop protection composition.

In particular, the composition of the invention is a personal care or a homecare composition, such as a body care composition (including cosmetic compositions), a cleaning composition (including dishwashing compositions) or a textile detergent composition.

The compositions according to the invention can further comprise one or more substances, such as, for example: preservatives, abrasives, anti-acne agents, agents to combat skin aging, antibacterial agents, anti-cellulite agents, antidandruff agents, anti-inflammatory agents, irritation-preventing agents, irritation-alleviating agents, antimicrobial agents, antioxidants, astringents, sweat-inhibiting agents, antiseptics, antistatics, binders, buffers, carrier materials, chelating agents, cell stimulants, cleaning agents, care agents, hair removal agents, surface-active substances, deodorizing agents, antiperspirants, emulsifiers, enzymes, essential oils, fibers, film formers, fixatives, foam formers, foam stabilizers, substances for preventing foaming, foam boosters, fungicides, gelling agents, gel-forming agents, hair care agents, hair shaping agents, hair smoothing agents, moisture-donating agents, moisturizing substances, humectant substances, bleaching agents, strengthening agents, stain removal agents, optical brighteners, impregnating agents, soil repellents, friction-reducing agents, lubricants, moisturizing creams, ointments, opacifiers, plasticizers, covering agents, polish, shine agents, polymers, powders, proteins, refatting agents, exfoliating agents, silicones, skin-calming agents, skin-cleansing agents, skin care agents, skin-healing agents, skin lightening agents, skin-protective agents, skin-softening agents, cooling agents, skin-cooling agents, warming agents, skin-warming agents, stabilizers, UV-absorbent agents, UV filters, fabric softeners, suspending agents, skin-tanning agents, thickeners, vitamins, waxes, fats, phospholipids, saturated fatty acids, mono- or polyunsaturated fatty acids, α-hydroxy acids, polyhydroxy fatty acids, liquefiers, dyes, color-protection agents, pigments, anti-corrosives, polyols, electrolytes, or silicone derivatives.

In one preferred embodiment, the composition of the invention is a homecare composition, in particular a dishwashing composition, laundry composition or a surface cleaning composition. Such compositions comprise at least one surfactant and often at least one of following components: Sequestrants, enzymes, foamers, foam stabilizers, antimicrobials, pH adjusting agents (acid or base), and if the composition is liquid or gel like also water and optionally also an organic solvent.

Just by way of example, such a composition can comprise
(a) 0.1 to 40% by weight, relative to the total weight of the composition, of one or more surfactants;
(b) 0.01 to 5% by weight of one or more 1,4-butanediol mono- or diesters of the formula (I) as defined above;
(c) 0 to 15% by weight, relative to the total weight of the composition, of at least one organic solvent;
(d) 0 to 6 by weight, relative to the total weight of the composition, of at least one enzyme;
(e) 0 to 20% by weight, relative to the total weight of the composition, of at least one sequestrant;
(f) 0 to 8% by weight, relative to the total weight of the composition, of at least one defoamer and/or foam stabilizer;
(g) optionally a pH adjusting agent; amount adapted to obtain the desired pH;
(h) 0 to 50% by weight, relative to the total weight of the composition, of a further additive;
(i) optionally water ad 100%.

Suitable surfactants of component (a) correspond to those listed above. They can be non-ionic, anionic, cationic, zwitterionic or amphoteric. Generally, mixtures of two or more surfactants are used.

Suitable solvents of component (c) are for example C₂-C₃-alkanols (e.g. ethanol, n-propanol, isopropanol), C₂-C₃-alkanediols (e.g. ethyleneglycol, propylene glycol), C₁-C₄-alkylmonoethers of C₂-C₃-alkanediols (e.g. ethylene glycol monomethyl ether, ethylene glycol monoethyl ether, ethylene glycol monopropyl ether, ethylene glycol mono-n-butyl ether (also termed butylglyol), propylene glycol monomethyl ether, propylene glycol monoethyl ether, propylene glycol monopropyl ether and propylene glycol mono-n-butyl ether), polyetherpolyols (e.g. polyethylene glycol, polypropylene glycol), C₁-C₃-alkylmonoethers of polyetherpolyols (e.g. polyethylene glycol monomethyl ether, polyethylene glycol monoethyl ether, polyethylene glycol mono-n-propyl ether, polyethylene glycol mono-n-butyl ether), 5-, 6- or 7-membered lactones which may be substituted by one or more C₁-C₁₂-alkyl groups (e.g. γ-butyrolactone, γ-valerolactone, γ-octalactone, γ-nonalactone, δ-valerolactone, δ-decanolactone, δ-dodecanolactone and ε-caprolactone); 5-, 6- or 7-membered cyclic carbonates which may be substituted by one or more C₁-C₁₂-alkyl groups (e.g. ethylene carbonate, propylene carbonate and butylene carbonate which may carry one or more C₁-C₁₂-alkyl substituents); aliphatic esters (e.g. ethyl acetate, propyl acetate, butyl acetate, methylpropionate and ethyl propionate), carboxamides (e.g. N,N-dimethylformamide, N,N-diethylformamide and N, N-dimethylacetamide) or mixtures thereof.

Suitable enzymes of component (d) are those typically used in laundry, dishwashing or surface cleaning compositions, such as hydrolases, e.g. proteases, esterases, glucosidases, lipases, DNAses, amylases, cellulases, mannanases, other glycosylhydrolases and mixtures of the aforementioned enzymes. All these hydrolases contribute to dissolution and removal of soil from protein-, grease- or starch-containing stains/residues. For bleaching, it is also possible to use oxidoreductases.

Sequestrants of component (e), also termed builders, structural substances, framework substances, complexing agents, chelators, chelating agents or softeners, bind alkaline earth metals and other water-soluble metal salts without precipitating. They help to break up soil, disperse soil components, help to detach soil and in some cases themselves have a washing effect. Many sequenstrants are multi-functional, meaning that the substances have additional functions, such as a dispersing activity or anti-greying properties. Suitable sequestrants may be either organic or inorganic in nature. Examples are aluminosilicates, carbonates, phosphates and polyphosphates, polycarboxylic acids, polycarboxylates, hydroxycarboxylic acids, phosphonic acids, e.g. hydroxyalkylphosphonic acids, phosphonates, aminopolycarboxylic acids and salts thereof, and polymeric compounds containing carboxylic acid groups and salts thereof. More specific examples for inorganic sequestrants are crystalline or amorphous aluminosilicates with ion-exchanging properties, such as zeolites; disilicates or sheet silicates; carbonates and hydrogencarbonates, generally in the form of their alkali metal, alkaline earth metal or ammonium salts; alkali metal orthophosphates and/or polyphosphates, for example pentasodium triphosphate. More specific examples for organic sequestrants are C₄-C₃₀-di-, -tri- and -tetracarboxylic acids, e.g. succinic acid, propanetricarboxylic acid, butanetetracarboxylic acid, cyclopentanetetracarboxylic acid, and alkyl- and alkenylsuccinic acids with C₂-C₂₀-alkyl or -alkenyl radicals; hydroxycarboxylic acids and polyhydroxycarboxylic acids (sugar acids), e.g. malic acid, tartaric acid, glutonic acid, mucic acid, lactic acid, glutaric acid, citric acid, tartronic acid, glucoheptonic acid, lactobionic acid, and sucrosemono-, -di- and -tricarboxylic acid; phosphonic acids, e.g. hydroxyalkylphosphonic acids or aminophosphonic acids, and the salts thereof; poly-asparatic acids and their salts; polymeric compounds containing carboxylic acid groups, such as acrylic acid homopolymers; oligomaleic acids, etc.

Defoamer and/or foam stabilizer of component (f) are for example soaps, paraffins and silicone oils.

pH adjusting agents of component (g) are acids, bases and buffering systems. The acids can be inorganic or organic. Suitable inorganic acids are for example sulfuric acid, hydrochloric acid and phosphoric acid. Suitable organic acids are for example aliphatic, saturated non-substituted C₁-C₆-mono-, di- and tri-carboxylic acids such as formic acid, acetic acid, propanoic acid, oxalic acid, succinic acid and glutaric acid; aliphatic, saturated C₁-C₆-mono-, di- and tri-carboxylic acids carrying one or more OH groups, such as lactic acid, tartric acid and citric acid; aliphatic, unsaturated C₁-C₆-mono-, di- and tri-carboxylic acids such as sorbic acid; aromatic carboxylic acids, such as benzoic acid, salicylic acid and mandelic acid; and sulfonic acids, such as methanesulfonic acid or toluenesulfonic acid. The organic acids mainly serve for adapting the pH of the composition, but some of them, e.g. the di-and tricarboxylic acids, can also act as sequestrants. Suitable bases are in particular inorganic bases, such as the carbonates mentioned in context with the sequestrant, e.g. sodium or potassium carbonate; further alkali metal and earth alkaline metal hydroxides, such as NaOH or KOH. Suitable buffering agents are the typical systems, such as hydrogenphosphate/dihydrogenphosphate buffer, carbonate/hydrogencarbonate buffer, acetic acid/acetate buffer or Tris buffer. Moreover, most of the above acids which are weak and the anion of which is not a strong salt also have buffering capacity.

Examples for further additives (h) are antimicrobials, including preservatives, fragrances different from (b), hydrotropic agents, enzyme stabilizers, bleaching agents, corrosion inhibitors, dyes, thickeners, activity enhancers and inorganic salts.

If the composition is liquid or gel-like, it mandatorily contains water, generally in an amount of 10 to 99.89% by weight, relative to the total weight of the composition. In liquid ready-to-use compositions (ready-to-use-compositions are compositions which are used as such and do not need any further dilution or addition of further substances), the amount of water is generally in the range of 30 to 99.89% by weight, often 40 to 99% by weight, relative to the total weight of the composition.

In a particular embodiment, the homecare composition is a refill concentrate. Refill concentrates contain all ingredients of the final ready-to-use product, but for water which is either essentially absent (“essentially” taking account of the fact that some of the ingredients may contain some residual water) or contained in amounts far below those of the final ready-to-use product. The end user has just to fill the refill concentrate into a suitable container and add the indicated amount of water.

Such refill concentrates preferably comprise:
(a) 1 to 60% by weight, relative to the total weight of the composition, of one or more surfactants;
(b) 0.02 to 10% by weight of one or more 1,4-butanediol mono- or diesters of the formula (I) as defined above;
(c) 0 to 30% by weight, relative to the total weight of the composition, of at least one organic solvent;
(d) 0 to 10% by weight, relative to the total weight of the composition, of at least one enzyme;
(e) 0 to 10% by weight, relative to the total weight of the composition, of at least one sequestrant;
(f) 0 to 10% by weight, relative to the total weight of the composition, of at least one defoamer and/or foam stabilizer;
(g) optionally a pH adjusting agent; amount adapted to obtain the desired pH;
(h) 0 to 50% by weight, relative to the total weight of the composition, of a further additive; and
(i) 0 to 20% by weight, relative to the total weight of the composition, of water;
   where components (a) to (i) add to 100% by weight.

In another preferred embodiment, the composition of the invention is a personal care composition. Personal care compositions can be such for hygienic or cosmetic use. Examples for suitable personal care compositions are given above.

Suitable personal care compositions may exist in a wide variety of forms, for example in the form of liquid preparations as a W/O, O/W, O/W/O, W/O/W or PIT emulsion and all kinds of microemulsions; in the form of a non-emulsified, water-based liquid, in the form of a gel, in the form of an oil, a cream, milk or lotion, in the form of a spray (spray with propellant gas or pump-action spray) or an aerosol, in the form of a foam, in the form of a paste, in the form of a wet wipe (such as for cleaning the nappy area). The personal care compositions may be, for example, creams, gels, lotions, alcoholic and aqueous/alcoholic solutions, emulsions, wax/fat compositions, or ointments. Ingredients typically present in such personal care compositions and their amounts vary according to the specific formulation. Examples for such ingredients are solvents, surfactants, emulsifiers, rheology modifiers (generally thickeners), conditioners, emollients, skin caring ingredients, lubricants, fillers, antioxidants, dermatologically active ingredients, fragrances and water.

Preparations intended mainly for cleaning, such as soaps, shower gels and shampoos, contain at least one or more surfactants, often of the anionic type, optionally in combination with such of the zwitterionic type; and water. Furthermore, they generally contain at least one of following components: emulsifier, sequestrant, fragrance, pH modifier (generally an organic acid and/or an inorganic base), inorganic salt (mostly NaCl), dye, pigment, preservative, pearlescer, opacifier, viscosity modifier, conditioning agent, natural hair nutrients, dermatologically active ingredient.

Of special interest are hair-washing preparations in the form of shampoos. Of special interest are moreover shower gels. Shampoos as well as shower gels generally contain water and at least one anionic surfactant.

Suitable anionic surfactants are principally all those described above which are cosmetically acceptable. The overall amount of anionic surfactant in shampoo and shower gel compositions generally ranges from 0.5 to 45% by weight, e.g. from 1.5 to 35% by weight, preferably from 2 to 20% by weight, based on the total weight of the composition. In shampoos and in shower gels, it is useful to use surfactants which are good foam-formers. The shampoo or shower gel composition can moreover include non-ionic, amphoteric and/or cationic co-surfactants, which help impart aesthetic, haptic, combing, physical or cleansing properties to the composition. Suitable non-ionic, amphoteric/zwitterionic and cationic surfactants are those described above. The overall amount of non-ionic surfactants in the shampoo or shower gel compositions generally ranges from 0.5 to 15% by weight, preferably from 2 to 10% by weight, the overall amount of amphoteric or zwitterionic surfactant in the shampoo or shower gel compositions generally ranges from 0.5 to 15% by weight, preferably from 1 to 10% by weight, and the overall amount of cationic surfactant in the shampoo or shower gel compositions generally ranges from 0.05 to 1% by weight, more preferably from 0.08 to 0.5% by weight, based on the total weight of the composition. The total amount of surfactant (including any co-surfactant and/or any emulsifier) in a shampoo or shower gel composition is generally from 1 to 50% by weight, preferably from 2 to 40% by weight, more preferably from 10 to 25% by weight, based on the total weight of the composition.

In a shampoo or shower gel composition the 1,4-butanediol mono- or diester of the formula (I) is generally present in an amount of from 0.01 to 5% by weight, preferably from 0.01 to 2% by weight, in particular from 0.01 to 1% by weight, based on the total weight of the composition.

If the shampoo or shower gel composition is liquid or gel-like, this contains water; generally in an amount of from 30 to 98% by weight, preferably from 50 to 90% by weight, relative to the total weight of the composition.

Other components which may be present in the shampoo or shower gel are for example suspending agents, such as polyacrylic acids, cross-linked polymers of acrylic acid, copolymers of acrylic acid with a hydrophobic monomer, copolymers of carboxylic acid-containing monomers and acrylic esters, cross-linked copolymers of acrylic acid and acrylate esters, heteropolysaccharide gums and crystalline long chain acyl derivatives, the latter being preferably selected from ethylene glycol stearate, alkanolamides of fatty acids having from 16 to 22 carbon atoms and mixtures thereof; fragrances different from 1,4-butanediol mono- and diacetate, dyes and pigments, pH adjusting agents, preservatives, pearlescers or opacifiers, viscosity modifiers, and salts, such as as NaCl; in shampoos moreover conditioning agents, natural hair nutrients or dermatologically active ingredients, such as botanicals, fruit extracts, caffeine, panthenol, sugar derivatives, amino acids, such as hydrolized keratine or glycine, vegetable or hydrogenated vegetable oils.

The 1,4-butanediol mono- or diester of the formula (I) or the mixture of different 1,4-butanediol mono- and/or diesters of the formula (I) may be worked into in compositions simply by directly mixing them with the basic composition lacking only this/these compound(s). Alternatively, the 1,4-butanediol mono- or diester of the formula (1) or the mixture of different 1,4-butanediol mono- and/or diesters of the formula (I) may be mixed simultaneously or consecutively with the other components of the composition or with pre-formed mixtures of a part of the other components.

The 1,4-butanediol mono- or diester of the formula (I) or the mixture of different 1,4-butanediol mono- and/or diesters of the formula (I) may, in an earlier step, be entrapped with an entrapment material, for example, polymers, capsules, microcapsules and nanocapsules, liposomes, film formers, absorbents such as carbon or zeolites, cyclic oligosaccharides and mixtures thereof, or may be chemically bonded to substrates, which are adapted to release the compounds (I) upon application of an external stimulus such as light, enzyme, or the like, and then mixed with the composition.

The 1,4-butanediol mono- or diester of the formula (I) or the mixture of different 1,4-butanediol mono- and/or diesters of the formula (I) and compositions comprising these compounds according to the present invention can also be in microencapsulated form, spray-dried form, in the form of inclusion complexes or in the form of extrusion products. The properties can be further optimized by so-called “coating” with suitable materials with regard to a more targeted release of the scent, for which purpose preferably waxy synthetic substances such as e.g. polyvinyl alcohol are used.

The microencapsulation can take place for example by the so-called coacervation method with the help of capsule materials, e.g. made of polyurethane-like substances or soft gelatin. The spray-dried perfume oils can be produced for example by spray-drying an emulsion or dispersion comprising a 1,4-butanediol mono- or diester of the formula (I) or a mixture of different 1,4-butanediol mono- and/or diesters of the formula (I), or a composition of the present invention described herein, wherein carrier substances that can be used are modified starches, proteins, dextrin and vegetable gums. Inclusion complexes can be prepared e.g. by introducing dispersions of fragrance compositions and cyclodextrins or urea derivatives into a suitable solvent, e.g. water. Extrusion products can be produced by melting a compound of formula (I), or a mixture of different compounds (I), or a composition of the present invention described herein with a suitable wax-like substance and by extrusion with subsequent solidification, optionally in a suitable solvent, e.g. isopropanol.

Generally, the total amount of the one or more 1,4-butanediol mono- or diesters of the formula (I) in the compositions according to the present invention is typically adapted to the particular intended use or the intended application and can, thus, vary over a wide range. As a rule, the customary standard commercial amounts for scents are used.

The compositions according to the invention can comprise the compounds of formula (I) in an overall amount of from 0.001 to 99.9% by weight, preferably from 0.01 to 90% by weight, more preferably from 0.01 to 80%, in particular from 0.01 to 60% by weight, more particularly from 0.01 to 40% by weight, e.g. from 0.01 to 10% by weight or 0.01 to 15% by weight or 0.01 to 5% by weight or 0.05 to 5% by weight, based on the total weight of the composition.

In one embodiment of the invention, the compositions comprise the compounds of formula (I) in an overall amount of from 0.001 to 10 weight % or from 0.001 to 5 weight %, preferably from 0.01 to 2 weight % or from 0.05 to 5 weight %, based on the total weight of the composition.

The compounds of formula (I) not only have a pleasant aroma, especially fragrance; they are also readily available. In particular they can be readily produced with a reduced CO₂ footprint, e.g. by using renewable sources and/or by upcycling potentially hazardous C₁ gases, such as CO₂ or methane, sequestered from industrial or agricultural processes which otherwise would be released into the atmosphere.

The following examples serve as further illustration of the invention.

### EXAMPLES

Abbreviations:

MTBE methyl tert-butyl ether

### 1. Preparation Examples

### 1.1 Preparation of 1,4-butanediol Diacetate

25 g (0.28 mol) of 1,4-butanediol were mixed with 57 g (0.56 mol) of acetic acid anhydride and 400 mg Nafion® NR50 (acidic ion exchanger). The mixture was stirred at room temperature for 24 h. Then the reaction mixture was diluted with 200 ml water and stirred for additional 10 min. The mixture was slowly neutralized with 75 ml of NaHCO₃ to pH 8 and then extracted with MTBE. The MTBE phase was dried with MgSO₄ and the solvent was evaporated. The reaction product was distilled at 3 mbar and 94° C.

The product contained 0.3% of the monoester and 99.6% of the diester (GC area).

### 1.2 Preparation of 1,4-butanediol Diacetate of Higher Purity

Example 1.1 was repeated. The product was then subjected to column chromatography on silica as further purification step to yield a product containing <0.05% of the monoester (i.e. 1,4-butanediol monoacetate) and >99.9% of the diester (i.e. 1,4-butanediol diacetate).

### 1.3 Preparation of 1,4-butanediol Monoacetate

50 g (0.56 mol) of 1,4-butanediol were mixed with 28 g (0.27 mol) of acetic acid anhydride, 0.5 g of acetic acid and 400 mg of Nafion® NR50 (acidic ion exchanger). The mixture was stirred for 24 h at room temperature. Then the reaction mixture was diluted with 100 ml of water and stirred for additional 10 min. The mixture was slowly neutralized with 55 g of NaHCO₃ to pH 8 and then extracted with MTBE. The MTBE Phase was dried with MgSO₄ and the solvent was evaporated. According to GC analysis, the crude mixture contained 56.8% of the monoacetate and 27.2% of the diacetate. The reaction product was distilled at 3 mbar. The obtained 1,4-butanediol monoacetate had a purity (GC) of 92.4% (5.6% 1,4-butanediol diacetate, 1.7% 1,4-butanediol).

### 1.4 Preparation of a 99:1 Mixture of 1,4-butanediol Diacetate and 1,4-butanediol Monoacetate

1,4-Butanediol diacetate of example 1.1 and 1,4-butanediol monoacetate of example 1.3 were mixed so as to result in a mixture of 1,4-butanediol diacetate and 1,4-butanediol monoacetate in a weight ratio of 99:1.

### 1.5 Preparation of a 98:2 Mixture of 1,4-butanediol Diacetate and 1,4-butanediol Monoacetate

1,4-Butanediol diacetate of example 1.1 and 1,4-butanediol monoacetate of example 1.3 were mixed so as to result in a mixture of 1,4-butanediol diacetate and 1,4-butanediol monoacetate in a weight ratio of 98:2.

### 1.6 Preparation of a 95:5 Mixture of 1,4-butanediol Diacetate and 1,4-butanediol Monoacetate

1,4-Butanediol diacetate of example 1.1 and 1,4-butanediol monoacetate of example 1.3 were mixed so as to result in a mixture of 1,4-butanediol diacetate and 1,4-butanediol monoacetate in a weight ratio of 95:5.

### 1.7 Preparation of a 90:10 Mixture of 1,4-butanediol Diacetate and 1,4-butanediol Monoacetate

1,4-Butanediol diacetate of example 1.1 and 1,4-butanediol monoacetate of example 1.3 were mixed so as to result in a mixture of 1,4-butanediol diacetate and 1,4-butanediol monoacetate in a weight ratio of 90:10.

### 1.8 Preparation of a 80:20 Mixture of 1,4-butanediol Diacetate and 1,4-butanediol Monoacetate

1,4-Butanediol diacetate of example 1.1 and 1,4-butanediol monoacetate of example 1.3 were mixed so as to result in a mixture of 1,4-butanediol diacetate and 1,4-butanediol monoacetate in a weight ratio of 80:20.

### 1.9 Preparation of of 1,4-butanediol Dipropionate

18 g (0.2 mol) of 1,4-butanediol were mixed with 52 g (0.4 mol) of propionic acid anhydride and 1 g of Nafion® NR50 (acidic ion exchanger). The mixture was stirred for 72 h at room temperature. Then the reaction mixture was diluted with 100 ml of water and stirred for additional 10 min. The mixture was slowly neutralized with 60 g of NaHCO₃ to pH 8 and then extracted with MTBE. The MTBE phase was dried with MgSO₄ and the solvent was evaporated. The mixture was distilled at 25 mbar (165° C.). The obtained 1,4-butanediol dipropionate had a purity (GC) of 97.3% (2.6% monopropionate).

### 2. Olfactory Tests

In order to test the quality and intensity of the odor of the compounds (I) of the present invention, scent strip tests were performed.

For this purpose, strips of absorbent paper were dipped into solution containing 1 to 10% by weight solution of the compound (I) to be tested triethylcitrate. After evaporation of the solvent (about 30 sec.) the scent impression was olfactively evaluated by a panel of trained perfumers.

The results of the scent test are summarized in the following.

Results of the scent tests.

### Product of Example 1.1:

Red fruit, raspberry, sweet, blueberry

### Product of Example 1.2:

Red fruit, raspberry, sweet, blueberry

### Product of Examples 1.4 to 1.8:

Same scent notes as for the product of example 1.1, but with fruitier impression which increases with increasing monoacetate content. In case of 1.6 to 1.8 the fruity impression is very clear. The scent becomes however weaker with increasing monoacetate content.

### Product of Example 1.9:

Same scent notes as for the product of example 1.1, but subtler

### Sales Products and Advantageous Fragrance Compositions

“Solution A” is the non-diluted product of example 1.1.
“Solution B” is the non-diluted product of example 1.2.
“Solution C” is the non-diluted product of example 1.4.
“Solution D” is the non-diluted product of example 1.5.
“Solution E” is the non-diluted product of example 1.6.
“Solution F” is the non-diluted product of example 1.7.
“Solution G” is the non-diluted product of example 1.8.
“Solution H” is the non-diluted product of example 1.9.

### I. Advantageous Fragrance Compositions:

Solution A as described above was formulated in the compositions according to table 2. The amounts given in table 2 are weight units in grams.

TABLE 2
Fragrance compositions 1A and 1B

| | 1A | 1B |
|---|---|---|
| Lactone C10 gamma (5-hexyloxolan-2-one) | 2 | 2 |
| Bourgeonal (3-(4-tert-butylphenyl)propanal) | 2 | 2 |
| Citronellol | 3 | 3 |
| Aldehyde C-14 (5-heptyloxolan-2-one) | 3 | 3 |
| Allyl heptylate | 4 | 4 |
| Amber core (1-(2-tert-butylcyclohexyl)oxybutan-2-ol) | 4 | 4 |
| Ethyl-2-methyl butyrate | 4 | 4 |
| Geranyl acetate | 5 | 5 |
| Helional ® (3-(1,3-benzodioxol-5-yl)-2-methylpropanal) | 10 | 10 |
| Manzanate (ethyl 2-methylpentanoate) | 10 | 10 |
| Amberwood ® (ethoxymethoxycyclododecane) | 10 | 10 |
| Hexyl acetate | 11 | 11 |
| Benzyl salicylate | 12 | 12 |
| Magnolan ® (2,4-dimethyl-4,4a,5,9b-tetrahydroindeno[1,2- | 15 | 15 |
| d][1,3]dioxine) | | |
| Verdox ® (2-tert-butylcyclohexyl) acetate) | 25 | 25 |
| Bergamot oil bergaptene free | 25 | 25 |
| Linalol | 30 | 30 |
| Dipropylene glycol | 45 | 45 |
| Iso E Super ® (Tetramethyl acetyloctahydronaphthalenes) | 110 | 110 |
| Pyranol (4-methyl-2-(2-methylpropyl)oxan-4-ol) | 170 | 170 |
| Hedione ® (methyl 3-oxo-2-pentylcyclopentaneacetate) | 200 | 200 |
| Galaxolide ® 50% IPM (1,3,4,6,7,8-hexahydro-4,6,6,7,8,8- | 300 | 300 |
| hexamethylcyclopenta(g)-2-benzopyran 50% in | | |
| isopropyl myristate) | | |
| Solution A | 25 | 50 |
| | 1025 | 1050 |

Solution A as described above was formulated in the compositions according to table 3. The amounts given in table 3 are weight units in grams.

TABLE 3
Fragrance compositions 2A and 2B

| | 2A | 2B |
|---|---|---|
| Raspberry ketone (4-(4-hydroxyphenyl)butan-2-one) | 4 | 4 |
| Vanitrope ® (2-ethoxy-5-prop-1-enylphenol) | 6 | 6 |
| Cyclamen aldehyde (at least 90% 2-methyl-3-(p- | 10 | 10 |
| isopropylphenyl)-propionaldehyde; secondary | | |
| component: 5% 3-(p-cumenyl)-2-methylpropionic acid) | | |
| Bicyclononalactone (3,4,4a,5,6,7,8,8a-octahydrochromen- | 10 | 10 |
| 2-one) | | |
| Aldehyde C-14 (5-heptyloxolan-2-one) | 14 | 14 |
| Ethylvanillin (3-ethoxy-4-hydroxybenzaldehyde) | 16 | 16 |
| Heliotropine (1,3-benzodioxole-5-carbaldehyde) | 20 | 20 |
| Iso E Super ® (tetramethyl acetyloctahydronaphthalenes) | 20 | 20 |
| Sandela ® (3-[5,5,6-trimethylbicyclo[2.2.1]hept-2- | 30 | 30 |
| yl]cyclohexan-1-ol) | | |
| Vanillin isobutyrate ((4-formyl-2-methoxyphenyl) 2- | 40 | 40 |
| methylpropanoate) | | |
| Aldehyde C-18 (5-pentyloxolan-2-one) | 50 | 50 |
| Benzyl salicylate | 60 | 60 |
| Hexyl cinnamic aldehyde (2-(phenylmethylidene)octanal) | 70 | 70 |
| Hedione ® (methyl 3-oxo-2-pentylcyclopentaneacetate) | 130 | 130 |
| Pyranol (4-methyl-2-(2-methylpropyl)oxan-4-ol) | 150 | 150 |
| Ethylene brassylate (1,4-dioxacycloheptadecane-5,17-dione) | 170 | 170 |
| Galaxolide ® 50% IPM (1,3,4,6,7,8-hexahydro-4,6,6,7,8,8- | 200 | 200 |
| hexamethylcyclopenta(g)-2-benzopyran 50% in isopropyl | | |
| myristate) | | |
| Solution A | 10 | 20 |
| | 1010 | 1020 |

Fragrance composition 3 corresponds to fragrance composition 1A, where Solution A is replaced by the same amount of Solution B. Fragrance composition 4 corresponds to fragrance composition 1B, where Solution A is replaced by the same amount of Solution B. Fragrance composition 5 corresponds to fragrance composition 2A, where Solution A is replaced by the same amount of Solution B. Fragrance composition 6 corresponds to fragrance composition 2B, where Solution A is replaced by the same amount of Solution B.

Fragrance composition 7 corresponds to fragrance composition 1A, where Solution A is replaced by the same amount of Solution C. Fragrance composition 8 corresponds to fragrance composition 1B, where Solution A is replaced by the same amount of Solution C. Fragrance composition 9 corresponds to fragrance composition 2A, where Solution A is replaced by the same amount of Solution C. Fragrance composition 10 corresponds to fragrance composition 2B, where Solution A is replaced by the same amount of Solution C.

Fragrance composition 11 corresponds to fragrance composition 1A, where Solution A is replaced by the same amount of Solution D. Fragrance composition 12 corresponds to fragrance composition 1B, where Solution A is replaced by the same amount of Solution D. Fragrance composition 13 corresponds to fragrance composition 2A, where Solution A is replaced by the same amount of Solution D. Fragrance composition 14 corresponds to fragrance composition 2B, where Solution A is replaced by the same amount of Solution D.

Fragrance composition 15 corresponds to fragrance composition 1A, where Solution A is replaced by the same amount of Solution E. Fragrance composition 16 corresponds to fragrance composition 1B, where Solution A is replaced by the same amount of Solution E. Fragrance composition 17 corresponds to fragrance composition 2A, where Solution A is replaced by the same amount of Solution E. Fragrance composition 18 corresponds to fragrance composition 2B, where Solution A is replaced by the same amount of Solution E.

Fragrance composition 19 corresponds to fragrance composition 1A, where Solution A is replaced by the same amount of Solution F. Fragrance composition 20 corresponds to fragrance composition 1B, where Solution A is replaced by the same amount of Solution F. Fragrance composition 21 corresponds to fragrance composition 2A, where Solution A is replaced by the same amount of Solution F. Fragrance composition 22 corresponds to fragrance composition 2B, where Solution A is replaced by the same amount of Solution F.

Fragrance composition 23 corresponds to fragrance composition 1A, where Solution A is replaced by the same amount of Solution G. Fragrance composition 24 corresponds to fragrance composition 1B, where Solution A is replaced by the same amount of Solution G. Fragrance composition 25 corresponds to fragrance composition 2A, where Solution A is replaced by the same amount of Solution G. Fragrance composition 26 corresponds to fragrance composition 2B, where Solution A is replaced by the same amount of Solution G.

Fragrance composition 27 corresponds to fragrance composition 1A, where Solution A is replaced by the same amount of Solution H. Fragrance composition 28 corresponds to fragrance composition 1B, where Solution A is replaced by the same amount of Solution H. Fragrance composition 29 corresponds to fragrance composition 2A, where Solution A is replaced by the same amount of Solution H. Fragrance composition 30 corresponds to fragrance composition 2B, where Solution A is replaced by the same amount of Solution H.

The compositions according to tables 2 and table 3, namely 1A, 1B, 2A and 2B as well as fragrance compositions 3, 4, 5, 6, 7, 8, 9, 10, 11, 12, 13, 14, 15, 16, 17, 18, 19, 20, 21, 22, 23, 24, 25, 26, 27, 28, 29 and 30 could be included in various compositions selected from the group consisting of deo pump spray, clean hair-conditioner, face wash gel, foam bath concentrate, hair gel, self-foaming bodywash, sprayable sun care emulsion, sprayable sun protection emulsion, emollient facial gel, 2-phases oil foam bath, shampoos, shower bath, hydro-alcoholic AP/deo pump spray, aerosol, aqueous/alcoholic AP/deo roll-on, styling gel type “Out of Bed”, shaving foam, sensitive skin baby shampoo, body wash for sensitive skin, gloss enhancing shampoo for sensitive scalp, deo stick, baby wipe, after shave balm, face gel, face day care cream, face cleanser, body lotion, sun care SPF50+, sprayable lotion, hand dish cleaner—regular, hand dish cleaner—concentrate, sanitary cleaner—concentrate, all-purpose cleaner, anti-bacterial fabric softener, detergent composition, powder detergent composition and liquid detergent composition.

A person skilled in art may be well versed with the various general formulations for the above-mentioned products.

Compositions 1A, 1B, 2A, 2B, 3, 4, 5, 6, 7, 8, 9, 10, 11, 12, 13, 14, 15, 16, 17, 18, 19, 20, 21, 22, 23, 24, 25, 26, 27, 28, 29 and 30 can for example be formulated in specific formulations as disclosed in IP.com Number: IPCOM000258614D entitled New Aroma Chemicals pages 6 to 46, Table 1 to Table D13, wherein the “Fragrance Composition 1A” is replaced by identical amounts of compositions 1A, 1B, 2A, 2B, 3, 4, 5, 6, 7, 8, 9, 10, 11, 12, 13, 14, 15, 16, 17, 18, 19, 20, 21, 22, 23, 24, 25, 26, 27, 28, 29 or 30.

### II. Advantageous Fragrance Compositions

### II.1 Perfume Formulation for Various Uses

A base formulation of the composition listed in the following table was prepared. DPG is dipropylene glycol.

| Component | Parts by weight |
|---|---|
| Aldehyde C-09 10% in DPG | 70 |
| Aldehyde C-14 undecalactone | 200 |
| Allyl caproate | 200 |
| Amyl butyrate-N | 100 |
| Anisic aldehyde | 50 |
| Benzyl acetate | 100 |
| Cis-3-Hexenol | 40 |
| Cis-3-Hexenyl acetate | 100 |
| Cyclamen aldehyde | 100 |
| Damascone alpha | 50 |
| Decalactone gamma | 400 |
| Ethyl vanillin | 30 |
| Ethyl-2-methyl butyrate | 50 |
| Ethylene glycol brasylate | 2750 |
| Galbascone | 20 |
| Hedione | 200 |
| Helvetolide | 500 |
| Hexyl acetate | 250 |
| Ionone beta | 40 |
| Linalool | 3000 |
| Manzanate | 200 |
| Styryl acetate | 100 |
| Terpineol | 100 |
| Triplal | 100 |
| Verdox | 1000 |
| | 9750 |

To this base formulation 2.5% by weight of the product of example 1.1 was added. The resulting perfume formulation was olfactively evaluated as follows by a panel of trained perfumers:

The product of example 1.1 adds an own impression and signature to the base formulation, conferring to the perfume formulation a red fruit note and making it nicer, stronger, more natural, powerful and greener.

### II.2 Perfume Formulation for Various Uses

A base formulation of the composition listed in the following table was prepared. DPG is dipropylene glycol.

| Component | Parts by weight |
|---|---|
| Hexenyl acetate, cis-3 | 1 |
| Rose oxide | 1 |
| Calone 1951 | 2 |
| Ethyl-2-methyl butyrate | 2 |
| Manzanate | 2 |
| Floralozone | 4 |
| Hexenol, cis-3 10% in DPG | 4 |
| Hexyl acetate | 5 |
| Aldehyde C-14 | 10 |
| Allyl heptylate | 10 |
| Ethyl acetoacetate | 10 |
| Lavandin oil Abrialis | 10 |
| Cyclamen aldehyde | 14 |
| Isobornyl acetate | 20 |
| Dimethyl benzyl carbinyl acetate | 30 |
| Benzyl acetate | 40 |
| Dihydromyrcenol | 40 |
| Nopyl acetate | 50 |
| Verdox | 50 |
| Pyranol | 60 |
| Tonalid | 60 |
| Hexyl salicylate | 95 |
| Tetrahydrolinalool | 120 |
| Phenylethyl alcohol | 130 |
| PTBCHA | 130 |
| Dipropylene glycol | 100 |
| | 1000 |

This base formulation had a green, light fruity, slightly tropical sweet, floral of jasmine and rose scent with woody, musky backnotes.

To this base formulation, 100 parts by weight of the product of example 1.1 were added. The resulting perfume formulation was characterized by a panel of trained perfumers as more fruity and sweet, more raspberry, moreover the musk note was more pronounced. The product of example 1.1 thus also acts as a booster for musk notes.

### II.3 Perfume Formulation Intended for Use in Dishwashing Formulations

A base formulation of the composition listed in the following table for use in dishwashing formulations was prepared.

| Component | Parts by weight |
|---|---|
| Aldehyde C-08 | 20 |
| Aldehyde C-09 | 20 |
| Aldehyde C-10 | 50 |
| Aldehyde C-14 undecalactone | 200 |
| Allyl amyl glycolate | 100 |
| Anisic aldehyde | 50 |
| Benzaldehyde | 20 |
| Benzyl acetate | 400 |
| Cis-3-Hexenol | 150 |
| Cis-3-Hexenyl isobutyrate | 100 |
| Citral | 200 |
| Citronellal | 40 |
| Citronellol | 600 |
| Citronelyl nitrile | 200 |
| Cyclamen aldehyde | 100 |
| Decalactone gamma | 400 |
| Dihydromyrcenol | 700 |
| Diphenyl oxide | 80 |
| DPG | 270 |
| Geraniol | 600 |
| Geranyl acetate | 100 |
| Habanolide | 500 |
| Hedione | 500 |
| Hexyl cinnamic aldehyde N-alpha | 500 |
| Ionone beta | 100 |
| Isocyclocitral | 5 |
| Isobornyl acetate | 300 |
| Isomenthone | 15 |
| Linalool Giv. | 700 |
| Methyl anthranilate | 100 |
| Methyl benzoate | 40 |
| Methyl ionone | 150 |
| Oxane pure | 8 |
| Phenoxyethyl isobutyrate | 450 |
| Prenyl acetate | 100 |
| Styryl acetate | 100 |
| Terpineol | 300 |
| Terpenyl acetate | 500 |
| Tetrahydrolinalool | 230 |
| Trans-2-dodecenal | 2 |
| Piranol | 500 |
| | 9500 |

To this base formulation 500 parts by weight of the product of example 1.1 was added. The resulting perfume formulation was olfactively evaluated as follows by a panel of trained perfumers:

The product of example 1.1 adds a red fruit, strawberry, sweet note to the base formulation.

### II.4 Perfume Formulation Intended for Use in Reed Diffusers

A formulation of the composition listed in the following table for use in reed diffusers (scent dispenser where the scent is dispensed by slow evaporation supported by reeds) was prepared.

| Component | Parts by weight |
|---|---|
| Davana oil | 2 |
| Ethyl vanillin | 2 |
| Damascenone 10% in DPG | 4 |
| Raspberry ketone | 4 |
| Cinnamic aldehyde | 8 |
| Vetivert oil bourbon | 8 |
| Citral | 10 |
| Manzanate | 10 |
| Methyl pamplemousse | 10 |
| Vanillin | 10 |
| Ambroxan | 12 |
| Eugenol | 12 |
| Lemon oil sicilian | 12 |
| Pepper oil black | 12 |
| Ambrocenide 10 10% in DPG | 14 |
| Safranolide 1% in DPG | 14 |
| Cashmeran | 15 |
| Coumarin | 16 |
| Aldehyde C-16 | 20 |
| Cedramber | 20 |
| Ethyl linalool | 20 |
| Linalyl acetate | 25 |
| Sandalore | 25 |
| Ionone beta | 30 |
| Pyranol | 30 |
| Patchouli oil deironized | 35 |
| Pyranyl acetate | 50 |
| Galaxolide 50 DEP | 80 |
| Iso E super | 130 |
| Hedione | 160 |
| Dowanol DPM | 200 |
| Product of example 1.1 | 200 |
| | 1200 |

The resulting perfume formulation was olfactively evaluated by a panel of trained perfumers as sweeter, more fruity than without the product of example 1.1.

### II.5 Perfume Formulation Intended for Use in Shower Gel

A base formulation of the composition listed in the following table for use in shower gels was prepared.

| Component | Parts by weight |
|---|---|
| Aldehyde C-10 | 2 |
| Evernyl | 3 |
| Thiomenthone 1% in DPG | 4 |
| Indolarome | 5 |
| Methyl anthranilate | 5 |
| Liffarome | 7 |
| Melonal | 8 |
| Calone 1951 | 9 |
| Ligustral | 9 |
| Allyl amyl glycolate | 10 |
| Ethyl-2-methyl butyrate | 16 |
| Florhydral | 18 |
| Oxane 1% in DPG | 20 |
| Styrallyl acetate | 20 |
| Lactone C-12 gamma | 22 |
| Undecavertol | 22 |
| Aldehyde C-14 | 25 |
| Phenyl ethyl alcohol | 25 |
| Allyl cyclohexane propionate | 30 |
| Benzyl salicylate | 30 |
| Geranyl acetate | 30 |
| Benzyl acetate | 35 |
| Methyl ionone gamma | 35 |
| Cyclacet | 40 |
| Hexyl cinnamic aldehyde | 40 |
| Cyclamen aldehyde | 45 |
| Dihydromyrcenol | 50 |
| Habanolide | 55 |
| Pyranol | 80 |
| Linalool | 80 |
| Hedione | 170 |
| Product of example 1.1 | 50 |
| | 1000 |

The resulting perfume formulation was olfactively evaluated by a panel of trained perfumers as a tropical fruit blend with multiple fruit notes including watermelon, kiwi, pineapple, passionfruit and grapefruit on a floral, musky base.

An analogous formulation was prepared, containing however 50 parts by weight of DPG instead of the product of example 1.1. This was characterized as a bright, fresh tropical fruit blend with obvious notes of watermelon and floral musky undertones.

A comparison of the two blends revealed that the product of example 1.1 introduces a more natural effect and multiplies the various tropical notes, especially in the direction of pineapple. Watermelon remains, but it is better outbalanced, other fruits becoming better perceivable. The product of example 1.1 thus also acts as a booster for certain notes.

### II.6 Perfume Formulation Intended for Use in Shower Gel

A base formulation of the composition listed in the following table for use in shower gels was prepared.

| Component | Parts by weight |
|---|---|
| Hexenol cis-3- | 1 |
| Clary Sage Absolute | 2 |
| Ambroxan | 3 |
| Aldehyde C-14 | 4 |
| Grapefruit oil | 6 |
| Coriander oil Russian | 10 |
| Olibanum resinoid 50% | 10 |
| Petitgrain oil Paraguay | 12 |
| Evernyl | 12 |
| Heliotropine | 15 |
| Iso E Super | 15 |
| Tonalid | 15 |
| Mandarin oil green | 25 |
| Cedarwood oil Texas | 30 |
| Patchouli oil deironized | 30 |
| Vertofix Coeur | 30 |
| Bergamot oil | 40 |
| Coumarin | 40 |
| Pyranol | 40 |
| Hedione | 40 |
| Rosemary oil Tunisian | 40 |
| Dihydro myrcenol | 50 |
| Linalool | 50 |
| Galaxolide 50 | 60 |
| Linalyl acetate | 90 |
| Lavender oil Bulgarian | 100 |
| Lavandin oil Abrialis | 180 |
| Product of example 1.1 | 50 |
| | 1000 |

The resulting perfume formulation was olfactively evaluated by a panel of trained perfumers as a fresh, bright lavender fragrance with a dominant natural impression in a modern context provided by woody, musky and citrus elements.

An analogous formulation was prepared, containing however 50 parts by weight of DPG instead of the product of example 1.1. This was characterized as a classical lavender fragrance modernized with Dihydro myrcenol and Iso E Super and having a fresh citrus accord in the topnotes.

A comparison of the two blends revealed that the product of example 1.1 energizes the topnotes and delivers a more natural feel by virtue of its fruity notes which emphasize the ketonic notes of the lavandin and lavender.

### III. Ready-to-Use Compositions

### III.1 Shampoo or Shower Gel

A shampoo or shower gel formulation was prepared by mixing the following components in the given proportions:

| Trade name | INCI name/chemical name | Function | Amount [wt. %] |
|---|---|---|---|
| Dehyquart ® Guar | Guar hydroxypropyltrimonium | Conditioning agent | 0.30 |
| N | chloride | | |
| Texapon ® N 70 | Sodium laureth sulfate | Anionic surfactant | 12.86 |
| Dehyton ® PK 45 | Cocoamidopropyl betaine | Zwitterionic | 8.10 |
| | | surfactant | |
| Lamesoft ® | Coco glucoside, hydrogenated | Stabilizer | 1.50 |
| Balance | castor oil | | |
| Euperlan ® OP | Glycol distearate, sodium | Opacifier | 4.00 |
| White | laureth sulfate, cocoamido- | | |
| | propyl betaine, glyceryl | | |
| | oleate | | |
| | Sodium benzoate | Preservative | 0.50 |
| | Citric acid | pH adjustment | ad pH 6 |
| | Perfume composition from | Perfume | 1 |
| | example II.5 containing 5% | | |
| | of 1,4-butanediol diacetate | | |
| | of example 1.1 | | |
| | Water, demineralized | Solvent | Ad 100% |

The shower/shampoo formulation had a pleasant fruity fragrance of the notes listed in example II.5.

The analogous formulation containing 1% of the perfume composition from example II.6 instead of the perfume composition from example II.5 had a pleasant lavender fragrance of the notes listed in example II.6.

The analogous formulation containing 0.1% of 1,4-butanediol diacetate of example 1.1 instead of the perfume composition from example II.5 covered the unpleasant odor of the base formulation (i.e. above shampoo or shower gel formulation without perfume) well. The formulation containing 0.1% of 1,4-butanediol diacetate of example 1.1 instead of the perfume composition from example II.5 had a distinctive fruity scent.

### III.2 Laundry Detergent Formulation

A laundry detergent formulation was prepared by mixing the following components in the given proportions:

| Trade name | INCI name/chemical name | Function | Amount [wt. %] |
|---|---|---|---|
| Maranil ® DBS/LC | Linear C₁₀-C₁₃-alkyl | Anionic surfactant | 5.5 |
| | benzene sulfonate | | |
| Texapon ® N 70 | Sodium laureth sulfate | Anionic surfactant | 5.4 |
| Lutensol ® AO 7 | C₁₃-₁₅-Oxoalkoholethoxylate | Non-ionic surfactant | 5.4 |
| | with 7 EO | | |
| Edenor ® K 12-18 | Stripped coconut fatty acid | Additive | 2.4 |
| | 1,2-Propanediol | Solvent | 6.0 |
| | Ethanol | Solvent, | 2.0 |
| | | preservative | |
| | Na-citrate dihydrate | Sequestrant | 3.0 |
| | NaOH | pH adjustment | 2.2 |
| Actinide ® RS | 5-chloro-2-methyl-4- | Preservative | 0.5 |
| 1500 | isothiazolin-3-one (1.11%) | | |
| | and 2-methyl-4-isothiazolin- | | |
| | 3-one (0.37%) | | |
| Rheovis ® AT 120 | Methacrylic acid/acrylic acid | Thickener | 3 |
| | esters copolymer | | |
| | Perfume composition from | Perfume | 1 |
| | example II.1 containing | | |
| | 2.5% of 1,4-butanediol di- | | |
| | acetate of example 1.1 | | |
| | Water, demineralized | Solvent | Ad 100 |

The resulting clear and slightly yellowish formulation of a pH of 8.1 had a pleasant fruity fragrance of the notes listed in example II.1.

The analogous formulation containing 0.5% of 1,4-butanediol diacetate of example 1.1 instead of the perfume composition from example II.1 covered the unpleasant odor of the base formulation (i.e. above laundry detergent formulation without perfume) well. Increasing the amount of 1,4-butanediol diacetate of example 1.1 (but still below 1%) led to a distinctive fruity scent.

1.-22. (canceled)

23. Use of a 1,4-butanediol mono- or diester of the formula (I) 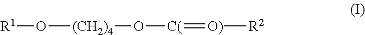
where
R¹ is selected from the group consisting of hydrogen and —C(═O)—R³; and
R² and R³, independently of each other, are C₁-C₂-alkyl;
or of a mixture of two or more different 1,4-butanediol mono- and/or diesters of the formula (I) as an aroma chemical.

24. The use according to claim 23, where
a 1,4-butanediol diester is used, wherein R¹ is —C(═O)—R³ and R² and R³ are both C₁-C₂-alkyl; or
a mixture of a 1,4-butanediol diester, wherein R¹ is —C(═O)—R³ and R² and R³ are both C₁-C₂-alkyl, and a 1,4-butanediol monoester, wherein R¹ is hydrogen and R² is C₁-C₂-alkyl, is used.

25. The use according to claim 23, where
R¹ is hydrogen or —C(═O)—CH₃; and
R² is methyl.

26. The use according to claim 25, of 1,4-butanediol diacetate.

27. The use according to claim 25, of a mixture of 1,4-butanediol diacetate and 1,4-butanediol monoacetate.

28. The use according to claim 25, of 1,4-butanediol dipropionate.

29. The use according to claim 25, of a mixture of 1,4-butanediol dipropionate and 1,4-butanediol monopropionate.

30. The use according to claim 24, where the mixture contains the 1,4-butanediol monoester in an amount of from 0.01 to 99% by weight, relative to the overall weight of the 1,4-butanediol diester and the 1,4-butanediol monoester.

31. The use according to claim 30, where the mixture contains the 1,4-butanediol monoester in an amount of from 0.1 to 10% by weight relative to the overall weight of the 1,4-butanediol diester and the 1,4-butanediol monoester.

32. The use according to claim 23, where the 1,4-butanediol mono- and/or diester of the formula (I) is derived from 1,4-butanediol which is obtained from a renewable source, where in the 1,4-butanediol mono- and/or diester of the formula (I) the molar ratio of the ¹²C isotope to the ¹⁴C isotope is less than 3×10¹²: 1; where the 1,4-butanediol mono- and/or diester of the formula (I) is derived from 1,4-butanediol which is obtained from a renewable source and from a carboxylic acid R²—C(═O)OH and R³—C(═O)OH, if R¹ is —C(═O)—R³, which is/are obtained from a renewable source.

33. The use according to claim 23, as a fragrance.

34. The use of a 1,4-butanediol mono- or diester of the formula (I) or of a mixture of different 1,4-butanediol mono- and/or diesters of the formula (I) as defined in claim 23, for modifying and/or enhancing the aroma of a composition.

35. The use of a 1,4-butanediol mono- or diester of the formula (I) or of a mixture of different 1,4-butanediol mono- and/or diesters of the formula (I) as defined in claim 23, for conferring a fruity or sweet or combined fruity and sweet olfactory note.

36. The use according to claim 23, in a composition selected from the group consisting of perfume compositions, body care compositions, products for oral or dental hygiene, hygiene articles, cleaning compositions, textile detergent compositions, compositions for scent dispensers, foods, food supplements, pharmaceutical compositions and crop protection compositions.

37. Composition comprising a 1,4-butanediol mono- or diester of the formula (I) or a mixture of different 1,4-butanediol mono- and/or diesters of the formula (I) as defined in claim 23, and at least one further component selected from the group consisting of aroma chemicals different from compounds (I), non-aroma chemical carriers, anti-oxidants and deodorant-active agents;
where the composition is not an alcoholic beverage, a fruit juice, a fruit or a seed, where the composition does not comprise diacetyl; and where the composition does not comprise 1,3-bis(caprolactam-1-yl) butane.

38. The composition according to claim 37, where in case that the non-aroma chemical carriers comprise one or more solvents, these are selected from the group consisting of ethanol, isopropanol, dipropylene glycol (DPG), propylene glycol, 1,2-butylene glycol, glycerol, diethylene glycol monoethyl ether, diethyl phthalate (DEP), isopropyl myristate (IPM), triethyl citrate (TEC), benzyl benzoate and mixtures thereof.

39. The composition according to claim 38, where the solvents are selected from the group consisting of isopropanol, dipropylene glycol (DPG), propylene glycol, 1,2-butylene glycol, diethylene glycol monoethyl ether, diethyl phthalate (DEP), isopropyl myristate (IPM), triethyl citrate (TEC), benzyl benzoate and mixtures thereof.

40. The composition according to claim 39, where the solvents are selected from the group consisting of isopropanol, isopropyl myristate (IPM), triethyl citrate (TEC), benzyl benzoate and mixtures thereof.

41. The composition according to claim 37, where the aroma chemicals different from compounds (I) are selected from the group consisting of geranyl acetate, alpha-hexylcinnamaldehyde, 2-phenoxyethyl isobutyrate, dihydromyrcenol, methyl dihydrojasmonate, 4,6,6,7,8,8-hexamethyl-1,3,4,6,7,8-hexahydrocyclopenta[g]benzopyran, tetrahydrolinalool, ethyllinalool, benzyl salicylate, 2-methyl-3-(4-tert-butylphenyl)propanal, cinnamyl alcohol, 4,7-methano-3a,4,5,6,7,7a-hexahydro-5-indenyl acetate, 4,7-methano-3a,4,5,6,7,7a-hexahydro-6-indenyl acetate, citronellol, citronellyl acetate, tetrahydrogeraniol, vanillin, linalyl acetate, styrolyl acetate, octahydro-2,3,8,8-tetramethyl-2-acetonaphthone, 2-acetyl-1,2,3,4,6,7,8-octahydro-2,3,8,8-tetramethylnaphthalene, hexyl salicylate, 4-tert-butylcyclohexyl acetate, 2-tert-butylcyclohexyl acetate, alpha-ionone, n-alpha-methylionone, alpha-isomethylionone, coumarin, terpinyl acetate, 2-phenylethyl alcohol, 4-(4-hydroxy-4-methylpentyl)-3-cyclohexenecarboxaldehyde, alpha-amylcinnamaldehyde, ethylene brassylate, (E)-3-methylcyclopentadec-5-enone, (Z)-3-methylcyclopentadec-5-enone, 15-pentadec-11-enolide, 15-pentadec-12-enolide, 15-cyclopentadecanolide, 1-(5,6,7,8-tetrahydro-3,5,5,6,8,8-hexamethyl-2-naphthalenyl)ethanone, 2-isobutyl-4-methyltetrahydro-2H-pyran-4-ol, 2-ethyl-4-(2,2,3-trimethyl-3-cyclopenten-1-yl)-2-buten-1-ol, cis-3-hexenyl acetate, trans-3-hexenyl acetate, trans-2/cis-6-nonadienol, 2,4-dimethyl-3-cyclohexenecarboxaldehyde, 2,4,4,7-tetramethyloct-6-en-3-one, 2,6-dimethyl-5-hepten-1-al, borneol, 3-(3-isopropylphenyl)butanal, 2-methyl-3-(3,4-methylenedioxyphenyl)propanal, 3-(4-ethylphenyl)-2,2-dimethylpropanal, 7-methyl-2H-1,5-benzodioxepin-3(4H)-one, 3,3,5-trimethylcyclohexyl acetate, 2,5,5-trimethyl-1,2,3,4,4a,5,6,7-octahydronaphthalen-2-ol, 3-(4-tert-butylphenyl)-propanal, ethyl 2-methylpentanoate, ethoxymethoxycyclododecane, 2,4-dimethyl-4,4a,5,9b-tetrahydroindeno[1,2-d][1,3]dioxine, (2-tert-butylcyclohexyl) acetate, 3-[5,5,6-trimethylbicyclo[2.2.1]hept-2-yl]cyclohexan-1-ol, menthone, isomenthone, carvone, camphor, beta-ionone, beta-n-methylionone, beta-isomethylionone, alpha-irone, alpha-damascone, beta-damascone, beta-damascenone, delta-damascone, acetylated cedar wood oil, and mixtures thereof.

42. The composition according to claim 37, which is selected from the group consisting of perfume compositions, body care compositions, products for oral or dental hygiene, hygiene articles, cleaning compositions, textile detergent compositions, compositions for scent dispensers, and crop protection compositions.

43. A method for preparing an aroma chemical composition comprising incorporating a 1,4-butanediol mono- or diester of the formula (I) or a mixture of different 1,4-butanediol mono- and/or diesters of the formula (I) as defined in claim 23 into said composition; or mixing a 1,4-butanediol mono- or diester of the formula (I) or a mixture of different 1,4-butanediol mono- and/or diesters of the formula (I) as defined in claim 23 simultaneously or consecutively with the other components of said composition or with pre-formed mixtures of a part of the other components of said composition.

44. A method for conferring an aroma to a composition, comprising incorporating a 1,4-butanediol mono- or diester of the formula (I) or a mixture of different 1,4-butanediol mono- and/or diesters of the formula (I) as defined in claim 23 into said composition; or comprising mixing a 1,4-butanediol mono- or diester of the formula (I) or a mixture of different 1,4-butanediol mono- and/or diesters of the formula (I) as defined in claim 23 simultaneously or consecutively with the other components of said composition or with pre-formed mixtures of a part of the other components of said composition.
